(19) United States
(12) Patent Application Publication
(10) Pub. No.: US 2026/0019142 A1
(43) Pub. Date: Jan. 15, 2026

(54) NETWORK-CONTROLLED REPEATER, BASE STATION AND METHOD

(71) Applicant: Sony Group Corporation, Tokyo (JP)

(72) Inventors: Vivek SHARMA, Basingstoke (GB); Yassin Aden AWAD, Basingstoke (GB); Yuxin WEI, Basingstoke (GB); Hideji WAKABAYASHI, Basingstoke (GB)

(73) Assignee: Sony Group Corporation, Tokyo (JP)

(21) Appl. No.: 18/997,883

(22) PCT Filed: Jul. 31, 2023
(86) PCT No.: PCT/EP2023/071194

§ 371 Date: Jan. 23, 2025

(30) Foreign Application Priority Data
Aug. 3, 2022 (EP) 22188567.6

(51) Int. Cl. H04B 7/155; H04L 5/14

(52) U.S. Cl. CPC H04B 7/15542; H04L 5/14

(57) ABSTRACT

The present disclosure relates to a network-controlled repeater for a mobile telecommunications network, wherein the network-controlled repeater includes circuitry configured to detect a radio link failure in a connection between the network-controlled repeater and a cell provided by a base station of the mobile telecommunications network; and release, based on the detected radio link failure, a first configuration of a forwarding function of the network-controlled repeater.

### TECHNICAL FIELD

The present disclosure generally pertains to a network-controlled repeater, a base station and a method.

### TECHNICAL BACKGROUND

Several generations of mobile telecommunications systems are known, e.g., the third generation (3G), which is based on the International Mobile Telecommunications-2000 (IMT-2000) specifications, the fourth generation (4G), which provides capabilities as defined in the International Mobile Telecommunications-Advanced Standard (IMT-Advanced Standard), and the current fifth generation (5G), which has recently been put into practice and which is still being developed further.

A wireless communication technology that provides the requirements of 5G is termed New Radio (NR) Access Technology. Some aspect of NR is based on Long Term Evolution (LTE) technology, which is a wireless communications technology allowing high-speed data communications for mobile phones and data terminals, and which is already used for 4G mobile telecommunications systems. LTE and NR are standardized under the control of 3GPP (3rd Generation Partnership Project).

Additionally, a new study item on a network-controlled repeater (also called smart repeater) for 5G was agreed.

Although there exist techniques for a network-controlled repeater, it is generally desirable to provide an improved technique for a network-controlled repeater.

### SUMMARY

According to a first aspect, the disclosure provides a network-controlled repeater for a mobile telecommunications network, wherein the network-controlled repeater comprises circuitry configured to detect a radio link failure in a connection between the network-controlled repeater and a cell provided by a base station of the mobile telecommunications network; and release, based on the detected radio link failure, a first configuration of a forwarding function of the network-controlled repeater.

According to a second aspect, the disclosure provides a base station for a mobile telecommunications network, wherein the base station comprises circuitry configured to detect a radio link failure in a connection between a network-controlled repeater of the mobile telecommunications network and a cell provided by the base station; and release, based on the detected radio link failure, a first configuration of a forwarding function of the network-controlled repeater.

According to a third aspect, the disclosure provides a method for a mobile telecommunications network, wherein the mobile telecommunications network includes a network-controlled repeater and a base station; wherein the method comprises detecting a radio link failure in a connection between the network-controlled repeater and a cell provided by the base station; and releasing, based on the detected radio link failure, a first configuration of a forwarding function of the network-controlled repeater

According to a fourth aspect, the disclosure provides a network-controlled repeater for a mobile telecommunications network, wherein the network-controlled repeater comprises circuitry configured to detect a radio link failure in a connection between the network-controlled repeater and a cell provided by a base station of the mobile telecommunications network; and transmit, to the base station, a connection re-establishment request message that includes an indication of a radio link failure of the network-controlled repeater as re-establishment cause.

According to a fifth aspect, the disclosure provides a user equipment for a mobile telecommunications network, wherein the user equipment comprises circuitry configured to detect a radio link failure in a connection between the user equipment and a cell provided by a base station of the mobile telecommunications network; and transmit, to the base station, a connection re-establishment request message that includes an indication of a radio link failure of the user equipment as re-establishment cause.

According to a sixth aspect, the disclosure provides a base station for a mobile telecommunications network, wherein the base station comprises circuitry configured to detect a radio link failure in a connection between a network entity of the mobile telecommunications network and a cell provided by the base station; and receive, from the network entity, a connection re-establishment request message that includes an indication of a radio link failure of the network entity as re-establishment cause.

According to a seventh aspect, the disclosure provides a method for a mobile telecommunications network, wherein the mobile telecommunications network includes a base station and a network entity; wherein the method comprises detecting a radio link failure in a connection between the network entity and a cell provided by the base station; and transmitting, from the network entity to the base station, a connection re-establishment request message that includes an indication of a radio link failure of the network entity as re-establishment cause.

Further aspects are set forth in the dependent claims, the drawings and the following description.

### BRIEF DESCRIPTION OF THE DRAWINGS

Embodiments are explained by way of example with respect to the accompanying drawings, in which:

FIG. 1 illustrates a network-controlled repeater connected to a gNB and a user equipment according to an embodiment;

FIG. 2 illustrates a first method for a mobile telecommunications system according to an embodiment;

FIG. 3 illustrates a second method for a mobile telecommunications system according to an embodiment;

FIG. 4 illustrates a third method for a mobile telecommunications system according to an embodiment;

FIG. 5 illustrates a fourth method for a mobile telecommunications system according to an embodiment;

FIG. 6 illustrates a fifth method for a mobile telecommunications system according to an embodiment;

FIG. 7 illustrates a sixth method for a mobile telecommunications system according to an embodiment;

FIG. 8 illustrates a user equipment, a network-controlled repeater and a base station according to an embodiment; and

FIG. 9 illustrates a general purpose computer according to an embodiment.

### DETAILED DESCRIPTION OF EMBODIMENTS

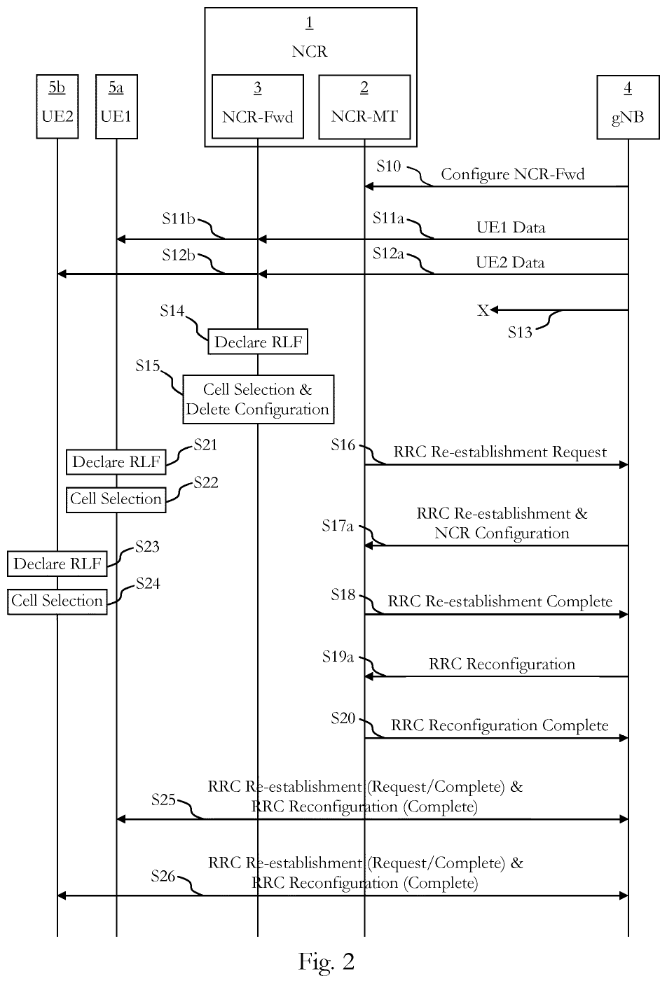

Before a detailed description of the embodiments under reference of FIG. 2 is given, general explanations are made.

As mentioned in the outset, a new study item on a network-controlled repeater (NCR; also called smart repeater) for 5G was agreed. The study item has the following objectives:

“The study on NR network-controlled repeaters is to focus on the following scenarios and assumptions:
Network-controlled repeaters are inband RF repeaters used for extension of network coverage on FR1 and FR2 bands, while during the study FR2 deployments may be prioritized for both outdoor and O2I scenarios.
For only single hop stationary network-controlled repeaters
Network-controlled repeaters are transparent to UEs
Network-controlled repeater can maintain the gNB-repeater link and repeater-UE link simultaneously

NOTE1: Cost efficiency is a key consideration point for network-controlled repeaters.

Study and identify which side control information below is necessary for network-controlled repeaters including assumption of max transmission power [RAN1]
Beamforming information
Timing information to align transmission/reception boundaries of network-controlled repeater
Information on UL-DL TDD configuration
ON-OFF information for efficient interference management and improved energy efficiency
Power control information for efficient interference management (as the 2nd priority)

Study and identify L1/L2 signaling (including its configuration) to carry the side control information [RAN1]

Study the following aspects of network-controlled repeater management
Identification and authorization of network-controlled repeaters [RAN2, RAN3]

NOTE2: Coordination with SA3 may be needed.”

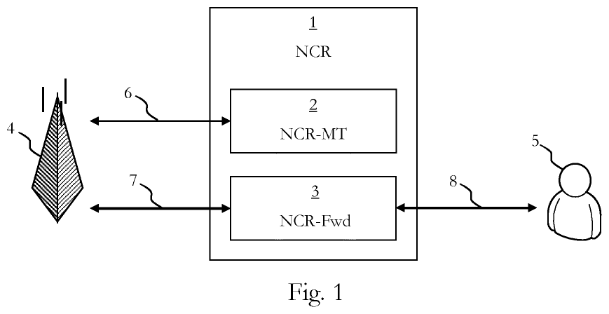

FIG. 1 illustrates an NCR connected to a gNB and a user equipment according to an embodiment. In some embodiments, as shown in FIG. 1, a network-controlled repeater (NCR) 1 is split into an NCR mobile termination (NCR-MT) function 2 and an NCR forwarding (NCR-Fwd) function 3. The NCR-MT 2 may be configured with a beam configuration, a Time Division Duplexing (TDD) configuration, a power control (if agreed) and an on/off configuration, and this configuration is used for the NCR-Fwd link.

The NCR 1 is connected to a gNB 4, which is a New Radio (NR) base station, and to a user equipment (UE) 5. The NCR-MT 2 is connected to the gNB 4 via a control link 6. The NCR-Fwd 3 is connected to the gNB 4 via a backhaul link 7 and is connected to the UE 5 via an access link 8.

The NCR-Fwd 3 forwards, via the backhaul link 7 and the access link 8, a connection between the gNB 4 and the UE 5. The NCR-MT 2 receives, via the control link 6, a configuration of the NCR-Fwd 3. For example, the configuration of the NCR-Fwd 3 may include the beam configuration, the TDD configuration, the power control and the on/off configuration mentioned above.

That is, even though the configuration mentioned above is used for the access link 8, it is received from the gNB 4 via the control link 6 (using radio resource control (RRC) or other signaling) in the NCR-MT 2 function.

In some embodiments, the NCR access link 8 may always relay common beams for all UEs 5 connected to the NCR 1.

It has been recognized that an NCR may suffer a radio link failure (RLF) in a connection to a gNB, and that there is a need for specifying how an NCR recovers from an RLF.

In some instances where an NCR-MT suffers an RLF while the NCR was serving UEs over an access link, all UEs on the NCR access link will also suffer an RLF as the cell, to which the NCR was connected, will simply disappear and no Uplink/Downlink (UL/DL) transmission/reception (tx/rx) will be possible anymore. The NCR-MT may declare an RLF, perform cell selection and perform a re-establishment procedure with a cell (or new cell) based on existing RLF procedure. All UEs served by the NCR may also suffer an RLF, perform cell selection and perform a re-establishment procedure.

There are two cases for re-establishment of the NCR-MT: The NCR re-establishes on either an earlier serving cell (temporary RLF) or another cell. If the NCR performs re-establishment on the same cell as it was camped before the RLF, re-establishment performed by UEs served by the NCR when detecting an access link RLF may be unnecessary and may bring a signaling burst when all UEs start performing a re-establishment procedure.

In some instances, there is no need to expedite re-establishment for these UEs under NCR. These UEs may most likely come back to the same cell and the same NCR. Also, if a re-establishment request from an NCR-MT and from these UEs includes a cell id same as previous cell id in the UE context then there may be no need to change security.

The current re-establishment procedure is specified in the 3GPP technical specification (TS) 38.331 version 16.8.0 dated 2022-03:

“The purpose of this procedure is to re-establish the RRC connection. A UE in RRC_CONNECTED, for which AS security has been activated with SRB2 and at least one DRB setup or, for IAB, SRB2, may initiate the procedure in order to continue the RRC connection. The connection re-establishment succeeds if the network is able to find and verify a valid UE context or, if the UE context cannot be retrieved, and the network responds with an RRCSetup according to clause 5.3.3.4.

The network applies the procedure e.g as follows:
When AS security has been activated and the network retrieves or verifies the UE context:
   to re-activate AS security without changing algorithms;
   to re-establish and resume the SRB1;
When UE is re-establishing an RRC connection, and the network is not able to retrieve or verify the UE context:
   to discard the stored AS Context and release all RBs and BH RLC channels;
   to fallback to establish a new RRC connection.

If AS security has not been activated, the UE shall not initiate the procedure but instead moves to RRC_IDLE directly, with release cause ‘other’. If AS security has been activated, but SRB2 and at least one DRB or, for IAB, SRB2, are not setup, the UE does not initiate the procedure but instead moves to RRC_IDLE directly, with release cause ‘RRC connection failure’.”

So, the current re-establishment procedure does not cover an NCR and, in addition, there is a room for improving failure handling for UEs connected to an NCR.

In some instances, an NCR-MT could be argued as an Integrated Access and Backhaul (IAB)-MT and the procedure may look like:

The NCR-MT may be allowed to initiate the re-establishment procedure without Data Radio Bearer (DRB), i.e., the Signaling Radio Bearer 2 (SRB2) may be sufficient, if Access Stratum (AS) security has been activated. If the SRB2 is not set up yet but AS security is set up, then the NCR-MT may move to IDLE mode. If AS security is not set up, then the NCR-MT may move to IDLE mode. This may be the same as for an IAB-MT.

As mentioned, RLF handling at an NCR-MT could be argued as similar to an IAB-MT but there are a few differences. IAB supports multihop with routing implemented in the Backhaul Adaptation Protocol (BAP) layer. An NCR only supports a single hop and routing is done in physical layer at an NCR.

So, a physical layer configuration of an NCR should be released when an RLF occurs so that the NCR is ready to accept a new configuration. Also, RLF handling at an NCR can be optimized so that an outage for UEs on the access link of the NCR can be avoided or minimized.

Therefore, in some embodiments, upon initiation of the RLF procedure and before sending a re-establishment request message, the NCR-MT may (this may be essential for the NCR to work and may be a new aspect) release a beam configuration, an on/off configuration and a TDD configuration so that the NCR-MT can accept a new configuration from a new cell. This may allow a gNB to release an NCR configuration after a certain time period. This time period may be equal to a duration of an RLF timer of the NCR-MT or gNB implementation specific.

Consequently, some embodiments pertain to a network-controlled repeater (NCR) for a mobile telecommunications network, wherein the network-controlled repeater includes circuitry configured to detect a radio link failure (RLF) in a connection between the network-controlled repeater and a cell provided by a base station of the mobile telecommunications network; and release, based on the detected RLF, a first configuration of a forwarding function of the network-controlled repeater.

The mobile telecommunications network may be based on 5G and New Radio (NR). The base station may include a 5G gNB and may provide a cell according to 5G. For example, the cell may include an NR cell. In some embodiments, the base station may provide a plurality of NR cells.

As discussed above, the NCR may include an NCR-MT function that is connected to the base station via a control link. The NCR may further include an NCR-Fwd function that is connected to the base station via a backhaul link and to a user equipment (UE) via an access link. The NCR-Fwd function may include a forwarding function of forwarding, according to the first configuration, a connection between the base station and the UE via the backhaul link and the access link. Thus, the first configuration may be a configuration of the forwarding function of the NCR-Fwd. The NCR-MT function may include receiving, via the control link, from the base station the first configuration of the forwarding function, for example based on Radio Resource Control (RRC) or similar signaling.

The NCR-Fwd function may be connected to a plurality of UEs, and the forwarding function may include forwarding connections between the base station and each of the plurality of UEs.

The NCR may detect the RLF if an RRC of the NCR receives a predetermined number of out-of-sync (OOS) indications from a physical layer and then a predetermined duration of an RLF timer of the NCR expires before synchronization is restored. Alternatively, the NCR may detect the RLF based on a Received Signal Strength Indicator (RSSI), a Received Signal Received Power (RSRP) and/or a Received Signal Received Quality (RSRQ) as well as on an RLF timer. For example, the NCR may detect the RLF if the RSSI, the RSRP and/or the RSRQ fall below a predetermined threshold for a predetermined duration indicated by the RLF timer.

The NCR may release the first configuration in response to detecting the RLF, e.g., before performing a cell selection or before transmitting a connection re-establishment request message or a connection establishment request message to a selected cell that has been selected in the cell selection. The releasing may include marking the first configuration for being deleted, overwritten or reused, based on a signaling (e.g., RRC signaling) received from the selected cell. For example, the releasing may include setting a release flag which indicates that the first configuration is released.

For example, a serving cell may support configuration via OAM (Operations, Administration and Maintenance; same vendor), but another cell may be selected after an RLF and a cell selection, and the other cell may indicate a second configuration of the NCR-Fwd different from the first configuration via RRC signaling. So, it is important in some embodiments that the NCR-MT releases the previous (first) configuration. In some embodiments, a base station such as a gNB may not hold a UE or NCR-MT context forever. For example, if an NCR suffered an electric supply outage lasting a few hours, then there may be no point for the gNB to keep the NCR-MT context as all connected UEs might have gone elsewhere. Alternatively, the NCR-MT may maintain the NCR-MT and NCR-Fwd configuration in a hope that an old and a new serving cell might be the same or might be provided by the same base station.

In some embodiments, the releasing of the first configuration includes deleting the first configuration. For example, the NCR may delete the first configuration if the selected cell is not the same cell as the cell provided by the base station, to which a connection has been interrupted by the detected RLF, or if the selected cell is not provided by the (same) base station. For example, the NCR may delete the first configuration if a base station providing the selected cell provides to the NCR a second configuration of the forwarding function, or if the base station providing the selected cell does not indicate to the NCR to reuse the first configuration. Thus, the NCR may delete the first configuration during or after RRC signaling with the base station providing the selected cell.

In some embodiments, the first configuration includes at least one of a beam configuration, an on/off configuration and a time division multiplexing configuration.

The beam configuration may indicate a beam used for communication in the backhaul link and/or in the access link. For example, the beam configuration may indicate a beam index, a frequency range of the beam and/or a timing of the beam. When an Intelligent Reflecting Surface (IRS) is used, the beam configuration may control the reflection amplitudes and/or phase shifts of the TRS.

The on/off configuration may indicate an on/off state of the NCR. For example, the on/off configuration may indicate an on/off pattern of the NCR, a periodicity of the on/off state, a schedule of the on/off state and/or a currently requested on/off state of the NCR.

The time division multiplexing configuration may indicate different time periods for uplink (UL) and downlink (DL) transmissions via the backhaul link and/or the access link. For example, the time division multiplexing configuration may indicate a time division duplexing (TDD) and a periodicity, pattern or schedule for UL/DL transmission of the TDD.

In some embodiments, the circuitry is configured to release the first configuration for accepting a second configuration of the forwarding function. The NCR may release the first configuration, on which the connection was based before the RLF occurred, because the NCR may not know whether the first configuration will be reused after re-establishing the connection to the base station or whether a second configuration different from the first configuration is used for the re-established connection.

In some embodiments, the second configuration includes at least one of a beam configuration, an on/off configuration and a time division multiplexing configuration. The second configuration may be used for a re-established connection to the base station instead of the first configuration. Thus, the second configuration may configure similar aspects (e.g., beam, on/off and/or time division multiplexing) of the connection to the base station as the first configuration. For example, the second configuration may configure a different value or option than the first configuration for at least one aspect of the connection to the base station.

In some embodiments, the circuitry is further configured to perform a cell selection in response to the detected RLF; and determine that a cell selected in the cell selection is provided by the base station. For example, the determining may include that the selected cell is a same cell as the cell to which a connection has been interrupted by the RLF. For example, the determining may include that the selected cell is another cell than the cell to which a connection has been interrupted by the RLF, but that the selected cell is also provided by the (same) base station.

For example, the cell selection may be based on an RSSI, an RSRP and/or an RSRQ of one or more cells that the NCR receives. The cell selection may further be based on a mobile network operator, a radio access technology, a status, a cell identifier, a frequency range and/or a maximum possible data rate of the one or more cells. For example, the NCR may preferably select the cell to which a connection has been interrupted by the RLF or a cell provided by the base station to which a connection has been interrupted by the RLF.

For example, if the selected cell is the same cell to which the connection has been interrupted by the RLF, the base station may retrieve the first configuration and/or a context associated with the NCR and/or associated with a UE connected to the base station via the NCR. Likewise, if the selected cell is another cell than the cell to which a connection has been interrupted by the RLF but is provided by the same base station, the base station may coordinate internally a context associated with the NCR and/or associated with a UE connected to the base station via the NCR such that the base station may retrieve the first configuration and/or the context associated with the NCR and/or associated with the UE connected to the base station via the NCR.

For example, in the cell selection, the NCR may be provided with a list of cells where it can expect a reuse of or a previous configuration and/or an expedited re-establishment, e.g., because the cells may be provided by the base station. For example, the list may be shared in a security protected message for establishing a trust later on. The NCR may preferably select a cell from the list.

In some embodiments, the determining is based on a cell identifier of the selected cell. For example, the determining may include determining that the cell identifier of the selected cell equals a cell identifier of the cell to which a connection has been interrupted by the RLF. For example, the determining may include determining that the cell identifier of the selected cell is associated with the (same) base station. The cell identifier may include a CellIdentity included in a Minimum System Information (MSI), e.g., in a System Information Block 1 (SIB1), and may be unique.

In some embodiments, the circuitry is further configured to transmit a connection re-establishment request message to the base station. The connection re-establishment request message may include an RRCReestablishmentRequest message.

In some embodiments, the circuitry is further configured to receive the second configuration from the base station. For example, the NCR may receive the second configuration when connecting to the selected cell. For example, the NCR may receive the second configuration via RRC signaling.

In some embodiments, the circuitry is further configured to request the second configuration from the base station. For example, the NCR may request the second configuration via RRC signaling. However, in some embodiments, the NCR may not transmit a request of the second configuration to the base station, and the base station may determine to transmit the second configuration to the NCR without receiving a request of the second configuration and may transmit the second configuration to the NCR after receiving the connection re-establishment request message or a connection reestablishment complete message.

In some embodiments, the requesting includes transmitting a request of the second configuration in the connection re-establishment request message. For example, the request may be indicated by a bit that the NCR sets in the connection re-establishment request message or by a value that the NCR includes into the connection re-establishment request message.

In some embodiments, the requesting includes transmitting a request of the second configuration in a connection re-establishment complete message. The connection re-establishment complete message may include an RRCReestablishmentComplete message. For example, the request may be indicated by a bit that the NCR sets in the connection re-establishment complete message or by a value that the NCR inserts into the connection re-establishment complete message.

In some embodiments, the receiving includes receiving the second configuration in a connection re-establishment message. The connection re-establishment message may include an RRCReestablishment message received from the base station for connecting to the selected cell. For example, the NCR may be configured to extract the second configuration from the connection re-establishment message.

In some embodiments, the receiving includes receiving the second configuration in a connection reconfiguration message. The connection reconfiguration message may include an RRCReconfiguration message received from the base station for connecting to the selected cell. For example, the NCR may be configured to extract the second configuration from the connection reconfiguration message.

In some embodiments, the connection re-establishment request message includes an indication of an RLF of the NCR as re-establishment cause. The re-establishment cause may include a ReestablishmentCause. The indication may include a value that is associated with an RLF in the NCR, e.g., in the NCR-MT. This may be indicated by using an existing cause value or new cause value. For example, in addition to re-establishment causes “reconfigurationFailure”, “handoverFailure”, “otherFailure” and “sparel” which are defined for a conventional 5G RRC Re-establishment Request message, a new re-establishment cause value may be defined which may indicate to the base station that the connection re-establishment request message comes from an NCR. The new re-establishment cause value may also indicate that the selected cell, to which the connection re-establishment request message is transmitted, is the same cell as the previous cell to which a connection has been interrupted by the RLF, and that the NCR is prepared to reuse the first configuration.

For example, quick recovery may be useful for cases where a quick change in radio conditions has triggered an RLF. In such a case, the NCR-MT may indicate, by including the indication of an RLF as re-establishment cause, to the base station, e.g. to a gNB, that it is capable of resuming quickly.

In some embodiments, the circuitry is further configured to receive a connection re-establishment message from the base station; and determine whether the connection re-establishment message includes a reuse indication for continuing providing the forwarding function based on the first configuration.

The connection re-establishment message may include an RRCReestablishment message. The reuse indication may include a bit or a value that is associated with an instruction to reuse the first configuration for a re-established connection to the base station.

In some embodiments, the circuitry is further configured to continue providing the forwarding function based on the first configuration if the connection re-establishment message includes the reuse indication.

For example, if the NCR detects the reuse indication in a connection re-establishment message, the NCR may configure the NCR-Fwd function according to the first configuration, that had previously been released.

For example, after receiving a connection re-establishment message that includes the reuse indication, the NCR may respond to the base station with a connection re-establishment complete message (e.g., including an RRCReestablishmentComplete message) and may stop expecting a connection reconfiguration message (e.g., an RRCReconfiguration message) from the base station.

For example, after receiving a connection re-establishment message that includes the reuse indication, the NCR may respond to the base station with a connection reconfiguration complete message (e.g., an RRCReconfigurationComplete message) for indicating that the NCR does not expect to receive a connection reconfiguration message (e.g., an RRCReconfiguration message).

For example, the NCR may, in response to a connection reconfiguration message (e.g., an RRCReconfiguration message) received after a connection re-establishment message that includes the reuse indication, respond to the base station with a connection reconfiguration complete message (e.g., an RRCReconfigurationComplete message) without extracting configuration information from the connection reconfiguration message (i.e., the connection reconfiguration message may be a “dummy” reconfiguration message) or at least without extracting from the connection reconfiguration message any configuration information that relates to a configuration of the NCR-Fwd function.

In some embodiments, the circuitry is further configured to receive the second configuration if the connection re-establishment message does not include the reuse indication. For example, the NCR may, in response to detecting that the connection re-establishment message does not include the reuse indication, extract configuration information that indicates the second configuration from the connection re-establishment message and/or from a connection reconfiguration message (e.g., an RRCReconfiguration message) received subsequently.

In some embodiments, the circuitry is further configured to receive from the base station in response to the connection re-establishment request message a connection reconfiguration message instead of a connection re-establishment message. The connection reconfiguration message may include an RRCReconfiguration message that follows after the connection re-establishment request instead of an RRCReestablishment message. For example, omitting a connection re-establishment message (e.g., an RRCReestablishment message) may accelerate the recovering from the RLF such that the forwarding function of the NCR-Fwd may be faster available again.

In some embodiments, the circuitry is further configured to trust the base station; and perform further security procedure after resuming providing the forwarding function. For example, for making the forwarding function of the NCR-Fwd faster available again, a mutual verification and/or authentication of the NCR and the base station may be postponed from the connection re-establishment signaling to a time when the forwarding function of the NCR-Fwd has been restored. In a case where the postponed mutual verification and/or authentication fails, the NCR and/or the base station may stop trusting the respective other one, the NCR may go to an idle state (e.g., to RRC_IDLE) and/or the base station may release the connection (e.g., based on an RRCRelease message), respectively.

In some embodiments, the detecting of the RLF is based on an RLF timer of the NCR. For example, the NCR may detect the RLF if an RRC of the NCR receives out of sync (OOS) indications from a physical layer and then a predetermined duration of the RLF timer expires.

For example, the NCR may detect the RLF if the NCR does not receive a message from the base station for a predetermined duration indicated by the RLF timer, or if an RSSI, an RSRP and/or an RSRQ is less than a predetermined threshold for a predetermined duration indicated by the RLF timer.

In some embodiments, the RLF timer of the NCR is configured to indicate the RLF after a shorter duration than an RLF timer of a UE connected to the NCR via the forwarding function.

For example, a duration of the RLF timer of the NCR for detecting an RLF may be configured such that the NCR can, after detecting an RLF, perform a cell selection, a connection re-establishment and a connection reconfiguration and resume the forwarding function of the NCR-Fwd such that a user equipment (UE) connected to the base station via the NCR may not detect an RLF at all during above said duration.

For example, in order to avoid all UEs under NCR performing re-establishment, an RLF timer for the NCR-MT may be smaller than for normal UEs so that the NCR declares an RLF before the UEs. If the NCR selects the same cell as before the RLF, then an RLF may be avoided for multiple UEs. On the other hand, in some embodiments, a too short duration of the RLF timer for the NCR may result in frequent RLFs. So a balance may be needed in the duration of the RLF timer of the NCR, but the duration may be shorter than for an RLF timer of a UE connected to the base station via the NCR. In some embodiments, RLF criteria of the NCR may include more sensitive thresholds for values of OOS indications from a physical layer to an RRC than corresponding RLF criteria of a UE connected to the base station via the NCR. In some embodiments, this is a network-specific implementation and has no impact on 3GPP or other mobile telecommunication standard specifications.

Accordingly, some embodiments pertain to a base station for a mobile telecommunications network, wherein the base station includes circuitry configured to detect an RLF in a connection between an NCR of the mobile telecommunications network and a cell provided by the base station; and release, based on the detected RLF, a first configuration of a forwarding function of the NCR. In some embodiments, the releasing of the first configuration includes deleting the first configuration. In some embodiments, the first configuration includes at least one of a beam configuration, an on/off configuration and a time division multiplexing configuration. In some embodiments, the releasing of the first configuration is based on a release timer of the base station. In some embodiments, the release timer is configured to indicate a release of the first configuration after a time period that corresponds to a duration of an RLF timer of the NCR. In some embodiments, the circuitry is further configured to receive a connection re-establishment request message from the NCR. In some embodiments, the circuitry is further configured to provide a second configuration of the forwarding function to the NCR. In some embodiments, the second configuration includes at least one of a beam configuration, an on/off configuration and a time division multiplexing configuration. In some embodiments, the circuitry is further configured to receive a request of the second configuration from the NCR. In some embodiments, the receiving includes receiving the request of the second configuration in the connection re-establishment request message. In some embodiments, the receiving includes receiving the request of the second configuration in a connection re-establishment complete message. In some embodiments, the providing includes transmitting the second configuration in a connection re-establishment message. In some embodiments, the providing includes transmitting the second configuration in a connection reconfiguration message. In some embodiments, the connection re-establishment request message includes an indication of an RLF of the NCR as re-establishment cause. In some embodiments, the circuitry is further configured to transmit, in a connection re-establishment message to the NCR, a reuse indication for continuing providing the forwarding function based on the first configuration. In some embodiments, the circuitry is configured to transmit the reuse indication if the base station holds a UE context of a UE connected to the NCR according to the first configuration. In some embodiments, the circuitry is configured to transmit the reuse indication if the base station holds an NCR mobile termination context of the NCR according to the first configuration. In some embodiments, the circuitry is configured to not transmit the reuse indication if the base station does not hold a UE context of a UE connected to the NCR according to the first configuration. In some embodiments, the circuitry is configured to not transmit the reuse indication if the base station does not hold an NCR mobile termination context of the NCR according to the first configuration. In some embodiments, the circuitry is further configured to transmit to the NCR in response to the connection re-establishment request message a connection reconfiguration message instead of a connection re-establishment message. In some embodiments, the circuitry is further configured to trust the NCR; and perform further security procedure after the NCR has resumed providing the forwarding function. In some embodiments, the circuitry is further configured to configure, for an RLF timer of the NCR, a shorter duration for detecting an RLF than for an RLF timer of a UE connected to the NCR via the forwarding function.

Accordingly, some embodiments pertain to a method for a mobile telecommunications network, wherein the mobile telecommunications network includes an NCR and a base station; wherein the method includes detecting an RLF in a connection between the NCR and a cell provided by the base station; and releasing, based on the detected RLF, a first configuration of a forwarding function of the NCR. In some embodiments, the releasing of the first configuration includes deleting the first configuration. In some embodiments, the first configuration includes at least one of a beam configuration, an on/off configuration and a time division multiplexing configuration. In some embodiments, the releasing, at the base station, of the first configuration is based on a release timer of the base station. In some embodiments, the release timer indicates a release of the first configuration after a time period that corresponds to a duration of an RLF timer of the NCR. In some embodiments, the method includes releasing, at the NCR, the first configuration for accepting a second configuration of the forwarding function. In some embodiments, the second configuration includes at least one of a beam configuration, an on/off configuration and a time division multiplexing configuration. In some embodiments, the method includes performing a cell selection in response to the detected RLF; and determining that a cell selected in the cell selection is provided by the base station. In some embodiments, the determining is based on a cell identifier of the selected cell. In some embodiments, the method further includes transmitting a connection re-establishment request message from the NCR to the base station. In some embodiments, the method further includes providing the second configuration from the base station to the NCR. In some embodiments, the method further includes requesting, by the NCR, the second configuration from the base station. In some embodiments, the requesting includes transmitting a request of the second configuration in the connection re-establishment request message. In some embodiments, the requesting includes transmitting a request of the second configuration in a connection re-establishment complete message. In some embodiments, the providing includes transmitting the second configuration in a connection re-establishment message. In some embodiments, the providing includes transmitting the second configuration in a connection reconfiguration message. In some embodiments, the connection re-establishment request message includes an indication of an RLF of the NCR as re-establishment cause. In some embodiments, the method further includes transmitting, in a connection re-establishment message from the base station to the NCR, a reuse indication for continuing providing the forwarding function based on the first configuration. In some embodiments, the base station transmits the reuse indication if the base station holds a UE context of a UE connected to the NCR according to the first configuration. In some embodiments, the base station transmits the reuse indication if the base station holds an NCR mobile termination context of the NCR according to the first configuration. In some embodiments, the base station does not transmit the reuse indication if the base station does not hold a UE context of a UE connected to the NCR according to the first configuration. In some embodiments, the base station does not transmit the reuse indication if the base station does not hold an NCR mobile termination context of the NCR according to the first configuration. In some embodiments, the method further includes continuing, by the NCR, providing the forwarding function based on the first configuration if the connection re-establishment message includes the reuse indication. In some embodiments, the method further includes receiving the second configuration if the connection re-establishment message does not include the reuse indication. In some embodiments, the method further includes transmitting from the base station to the NCR in response to the connection re-establishment request message a connection reconfiguration message instead of a connection re-establishment message. In some embodiments, the method further includes trusting the NCR and the base station; and performing further security procedure after resuming, by the NCR, providing the forwarding function. In some embodiments, the detecting, by the NCR, of the RLF is based on an RLF timer of the NCR. In some embodiments, the detecting, by the NCR, of the RLF includes indicating, by the RLF timer of the NCR, the RLF after a shorter duration than an RLF timer of a UE connected to the NCR via the forwarding function. In some embodiments, the method further includes configuring, by the base station, for the RLF timer of the NCR, the shorter duration for detecting an RLF than for the RLF timer of the UE.

Accordingly, some embodiments pertain to a mobile telecommunications system that includes an NCR as described above; and a base station as described above; wherein the circuitry of the NCR and the circuitry of the base station are configured to perform a method as described above.

Returning to FIG. 2, FIG. 2 illustrates a first method for a mobile telecommunications system according to an embodiment. The mobile telecommunications system includes the NCR 1 with the NCR-MT 2 and the NCR-Fwd 3. The mobile telecommunications system further includes the gNB 4, which is an NR base station according to 5G, and user equipments (UEs) UE1 5a and UE2 5b. The NCR 1 connects to a 5G cell provided by the gNB 4.

At S10, the gNB 4 transmits a first configuration of the NCR-Fwd 3, i.e., of a forwarding function of the NCR 1, to the NCR-MT 2 via the control link 6 (not shown in FIG. 2). The NCR-MT 2 receives the first configuration and the NCR 1 configures the NCR-Fwd 3 according to the first configuration. As mentioned above, the first configuration includes at least one of a beam configuration, an on/off configuration and a time division multiplexing configuration. S10 takes place once the NCR-MT 2 is in RRC_Connected mode and has been authorized by the network to operate as NCR 1.

The user equipments UE1 5a and UE2 5b are connected to the gNB 4 via the NCR 1.

At S11a, the gNB 4 transmits data for the UE1 5a to the NCR-Fwd 3 via the backhaul link 7 (not shown in FIG. 2) and the NCR-Fwd 3 receives the data. At S11b, the NCR-Fwd 3 forwards the data to the UE1 5a via the access link 8 (not shown in FIG. 2) and the UE1 5a receives the data.

Likewise, at S12a, the gNB 4 transmits data for the UE2 5b to the NCR-Fwd 3 via the backhaul link 7 and the NCR-Fwd 3 receives the data. At S12b, the NCR-Fwd 3 forwards the data to the UE2 5b via the access link 8 (not shown in FIG. 2) and the UE2 5b receives the data.

Similarly, the NCR-Fwd 3 may receive data from the UE1 5a or UE2 5b via the access link 8 and may forward the data to the gNB 4 via the backhaul link 7.

At S13, a radio link failure (RLF) occurs in the control link 6 and in the backhaul link 7; i.e., in a connection between the NCR 1 and the gNB 4. In the case of FIG. 2, the RLF is triggered by a quick change in radio conditions that transiently interrupts the connection between the NCR 1 and the gNB 4. During the interruption, the NCR 1 does not receive data transmitted by the gNB 4, and the gNB 4 does not receive data transmitted by the NCR 1.

At S14, the NCR 1 detects and declares an RLF. The RLF detection of the NCR 1 is based on an RLF timer of the NCR 1 that indicates an RLF if the NCR 1 receives a predetermined number of out-of-sync (OOS) indications and synchronization with the gNB 4 is not restored within a predetermined duration indicated by the RLF timer of the NCR 1.

In some embodiments, the gNB4 also detects the RLF and deletes the first configuration, which is an example of releasing the first configuration. In some embodiments, a release timer of the gNB 4 indicates to release (e.g., delete) the first configuration after a time period that is equal to a duration of the RLF timer of the NCR 1.

At S15, the NCR 1 performs a cell selection and deletes the first configuration of the NCR-Fwd 3 for accepting a second configuration of the NCR Fwd 3. The deleting of the first configuration is an example of releasing the first configuration.

In the cell selection, the NCR 1 selects the cell provided by the gNB 4 to which it has been connected before the RLF occurred and to which the connection has been interrupted by the RLF. The NCR 1 determines that the cell selected in the cell selection is the same as the cell to which it has been connected before the RLF. This determination is based on determining that a CellIdentity, which is a cell identifier, of the selected cell equals a CellIdentity of the cell to which it has previously been connected. Alternatively, the selected cell is another cell provided (e.g., controlled) by the same gNB 4 as the cell to which the connection has been interrupted by the RLF.

At S16, the NCR-MT 2 transmits an RRC Re-establishment Request message via the control link 6 to the gNB 4 and the gNB 4 receives the RRC Re-establishment Request message. The RRC Re-establishment Request message is an example of a connection re-establishment request message. The NCR 1 requests a re-establishment instead of an establishment of the connection because the NCR 1 has determined that it has been connected to the cell before the RLF.

At S17a, the gNB 4 transmits an RRC Re-establishment message via the control link 6 to the NCR-MT 2 and the NCR-MT 2 receives the RRC Re-establishment message. The RRC Re-establishment message is an example of a connection re-establishment message. The RRC Re-establishment message includes a configuration of the NCR 1, including a second configuration of the NCR-Fwd 3. Like the first configuration, the second configuration includes at least one of a beam configuration, an on/off configuration and a time division multiplexing configuration. The NCR 1 configures the NCR-Fwd 3 according to the second configuration.

At S18, the NCR-MT 2 transmits an RRC Re-establishment Complete message via the control link 6 to the gNB 4 and the gNB 4 receives the RRC Re-establishment Complete message. The RRC Re-establishment Complete message is an example of a connection re-establishment complete message.

At S19a, the gNB 4 transmits an RRC Reconfiguration message via the control link 6 to the NCR-MT 3 and the NCR-MT 3 receives the RRC Reconfiguration message. The RRC Reconfiguration message is an example of a connection reconfiguration message.

At S20, the NCR-MT 2 transmits an RRC Reconfiguration Complete message via the control link 6 to the gNB 4 and the gNB 4 receives the RRC Reconfiguration Complete message. The RRC Reconfiguration Complete message is an example of a connection reconfiguration complete message.

After S20, the NCR 1 and the gNB 4 can communicate to each other again via the control link 6 and via the backhaul link 7, and a forwarding of communication via the access link 8, the NCR-Fwd 3 and the backhaul link 7 is possible again.

In the meantime, i.e., between S13 and S20, the UE1 5a detects and declares an RLF at S21 and performs a cell selection at S22. When the NCR-Fwd 3 has resumed its forwarding function based on the second configuration, the UE1 5a selects the cell provided by the gNB 4 and forwarded by the NCR-Fwd 3.

Likewise, between S13 and S20, the UE2 5b detects and declares an RLF at S23 and performs a cell selection at S24. Similar to the UE1 5a, the UE2 5b selects the cell provided by the gNB 4 and forwarded by the NCR-Fwd 3.

At S25, the UE1 5a connects to the selected cell via the access link 8, the NCR-Fwd 3 and the backhaul link 7 by exchanging messages with the gNB 4. The connecting includes transmitting an RRC Re-establishment Request message, receiving an RRC Re-establishment message, transmitting an RRC Re-establishment Complete message, receiving an RRC Reconfiguration message and transmitting an RRC Reconfiguration Complete message.

Likewise, at S26, the UE2 5b connects to the selected cell via the access link 8, the NCR-Fwd 3 and the backhaul link 7 by exchanging messages with the gNB 4. The connecting includes transmitting an RRC Re-establishment Request message, receiving an RRC Re-establishment message, transmitting an RRC Re-establishment Complete message, receiving an RRC Reconfiguration message and transmitting an RRC Reconfiguration Complete message.

Thus, in some embodiments, the method of FIG. 1 allows to re-establish a connection between the NCR 1 and the gNB 4 after an RLF. Performing a connection re-establishment and a connection reconfiguration allows, in some embodiments, a faster recovering of the NCR 1 from an RLF and a faster resuming of the NCR-Fwd 3 forwarding function as compared to a new connection establishment and connection configuration.

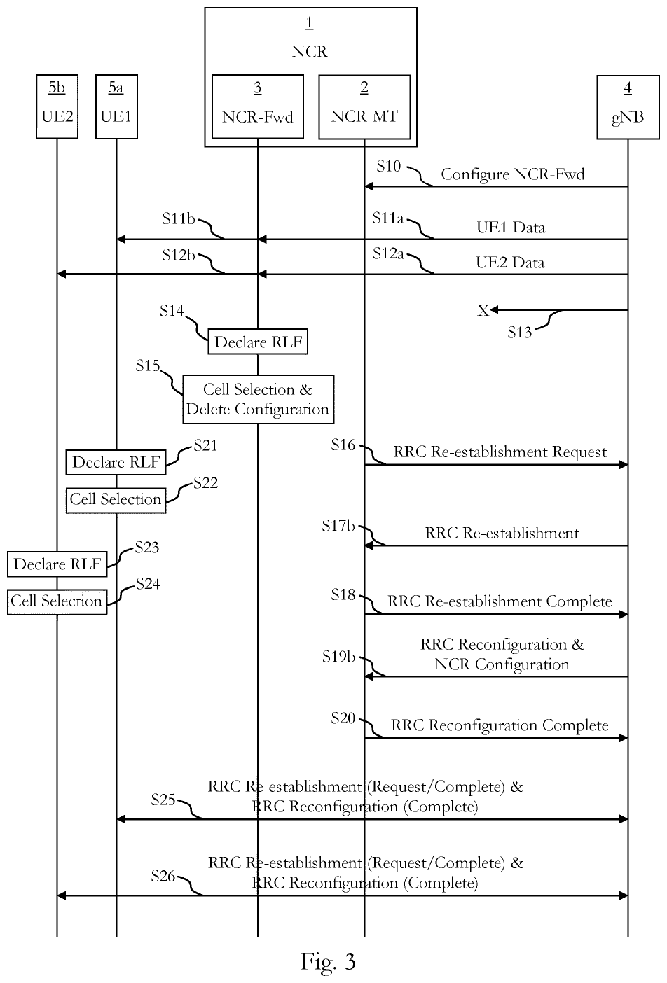

FIG. 3 illustrates a second method for a mobile telecommunications system according to an embodiment. The method of FIG. 3 is similar to the method of FIG. 2. Features of the method of FIG. 3 that have a same reference number as features of the method of FIG. 2 correspond to the respective features of the method of FIG. 2; for a detailed description, it is referred to the corresponding description of FIG. 2.

The difference between the method of FIG. 3 and the method of FIG. 2 is that the gNB 4 transmits the NCR configuration, which includes the second configuration of the NCR-Fwd 3, at S19b in the RRC Reconfiguration message instead of the RRC Re-establishment message, and that the NCR-MT 2 receives the second configuration at S19b. Accordingly, at S17b, the gNB 4 transmits the RRC Re-establishment message without the NCR configuration.

Thus, in some embodiments, in the method of FIG. 3, a receiving of the second configuration can easier be implemented because the second configuration is transmitted together with other configurations in the RRC Reconfiguration message.

However, in some embodiments, in the method of FIG. 2, the NCR-Fwd 3 can earlier resume providing the forwarding function because the NCR-MT 2 receives the second configuration earlier such that the NCR-Fwd 3 can be configured according to the second configuration from S17a on.

In some embodiments, the NCR 1 (including the NCR-MT 2 and the NCR-Fwd 3) and the gNB 4 include circuitry that is configured to perform the respective processing of the methods of FIG. 2 and/or FIG. 3.

Some embodiments pertain to a network-controlled repeater (NCR) for a mobile telecommunications network, wherein the NCR includes circuitry that is configured to detect a radio link failure (RLF) in a connection between the NCR and a cell provided by a base station of the mobile telecommunications network; and transmit, to the base station, a connection re-establishment request message that includes an indication of an RLF of the NCR as re-establishment cause.

As discussed above, the mobile telecommunications network may be based on 5G and New Radio (NR). The base station may include a 5G gNB and may provide a cell according to 5G. For example, the cell may include an NR cell. In some embodiments, the base station may provide a plurality of NR cells.

As discussed above, the NCR may include an NCR-Mobile Termination (NCR-MT) that is connected to the base station via a control link and an NCR-Fwd that is connected to the base station via a backhaul link and to one or more user equipments (UEs) via an access link. The NCR-Fwd may include a forwarding function of forwarding communication between the one or more UEs and the base station via the access link and the backhaul link. The NCR-MT may receive, e.g., based on Radio Resource Control (RRC) signaling via the control link, a first configuration of the forwarding function of the NCR for the connection. For example, the first configuration may include a configuration of the NCR-MT for communicating via the control link to the base station. For example, the first configuration may include a configuration of the NCR-Fwd for forwarding communication between the base station and the one or more UEs via the backhaul link and the access link, and the NCR may configure the NCR-Fwd according to the first configuration.

The NCR-Fwd may be connected to a plurality of UEs via the access link and may forward communication between the base station and each of the plurality of UEs.

The RLF may be an RLF in the NCR, e.g., in the NCR-MT. The NCR may detect the RLF if an RRC of the NCR receives a predetermined number of out-of-sync (OOS) indications from a physical layer and then a predetermined duration of an RLF timer of the NCR expires before synchronization is restored. Alternatively, the NCR may detect the RLF based on a Received Signal Strength Indicator (RSSI), a Received Signal Received Power (RSRP) and/or a Received Signal Received Quality (RSRQ) as well as on an RLF timer. For example, the NCR may detect the RLF if the RSSI, the RSRP and/or the RSRQ fall below a predetermined threshold for a predetermined duration indicated by the RLF timer.

The NCR may release the first configuration in response to detecting the RLF, e.g., before performing a cell selection or before transmitting the connection re-establishment request message to a selected cell that has been selected in the cell selection. The releasing may include marking the first configuration for being deleted, overwritten or reused, based on a signaling (e.g., RRC signaling) received from the selected cell. For example, the releasing may include setting a release flag which indicates that the first configuration is released.

The connection re-establishment message may include an RRCReestablishmentRequest message. The connection re-establishment message may include the indication of the RLF as re-establishment cause as a bit that can be set for indicating an RLF as re-establishment cause or as value that can be inserted into the connection re-establishment message for indicating an RLF as re-establishment cause. For example, in addition to re-establishment causes “reconfigurationFailure”, “handoverFailure”, “otherFailure” and “sparel” which are defined for a conventional 5G RRC Re-establishment Request message, a new re-establishment cause value may be defined which may indicate to the base station that the connection re-establishment request message comes from an NCR. The new re-establishment cause value may also indicate that the selected cell, to which the connection re-establishment request message is transmitted, is the same cell as the previous cell to which a connection has been interrupted by the RLF, and that the NCR is prepared to reuse the first configuration.

For example, quick recovery may be useful for cases where a quick change in radio conditions has triggered an RLF. In such a case, the NCR-MT may indicate, by including the indication of an RLF as re-establishment cause, to the base station, e.g. to a gNB, that it is capable of resuming quickly.

In some embodiments, the circuitry is further configured to perform a cell selection in response to the detected RLF; and determine that a cell selected in the cell selection is provided by the base station. For example, the determining may include that the selected cell is a same cell as the cell to which a connection has been interrupted by the RLF. For example, the determining may include that the selected cell is another cell than the cell to which a connection has been interrupted by the RLF, but that the selected cell is also provided by the (same) base station.

For example, the cell selection may be based on an RSSI, an RSRP and/or an RSRQ of one or more cells that the NCR receives. The cell selection may further be based on a mobile network operator, a radio access technology, a status, a cell identifier, a frequency range and/or a maximum possible data rate of the one or more cells. For example, the NCR may preferably select the cell to which a connection has been interrupted by the RLF or a cell provided by the base station to which a connection has been interrupted by the RLF.

For example, if the selected cell is the same cell to which the connection has been interrupted by the RLF, the base station may retrieve the first configuration and/or a context associated with the NCR and/or associated with a UE connected to the base station via the NCR. Likewise, if the selected cell is another cell than the cell to which a connection has been interrupted by the RLF but is provided by the same base station, the base station may coordinate internally a context associated with the NCR and/or associated with a UE connected to the base station via the NCR such that the base station may retrieve the first configuration and/or the context associated with the NCR and/or associated with the UE connected to the base station via the NCR.

For example, in the cell selection, the NCR may be provided with a list of cells where it can expect a reuse of or a previous configuration and/or an expedited re-establishment, e.g., because the cells may be provided by the base station. For example, the list may be shared in a security protected message for establishing a trust later on. The NCR may preferably select a cell from the list.

In some embodiments, the determining is based on a cell identifier of the selected cell. For example, the determining may include determining that the cell identifier of the selected cell equals a cell identifier of the cell to which a connection has been interrupted by the RLF. For example, the determining may include determining that the cell identifier of the selected cell is associated with the (same) base station. The cell identifier may include a CellIdentity included in a Minimum System Information (MSI), e.g., in a System Information Block 1 (SIB1), and may be unique.

In some embodiments, the circuitry is further configured to receive, from the base station, a reuse indication for connecting to the base station based on a first configuration of the connection in which the RLF has been detected.

For example, the first configuration may include a configuration of the NCR-MT and/or of the NCR-Fwd. The first configuration may include a configuration how the NCR-MT communicates with the base station via the control link. The first configuration may include a configuration how the NCR-Fwd forwards communication between the base station and the one or more UEs via the backhaul link and the access link.

The reuse indication may make a transmission of a second configuration of the NCR unnecessary such that the NCR may reuse the first configuration for connecting to the base station and less signaling is necessary for the connecting. Thus, the NCR may connect faster to the base station than if the NCR had to receive a second configuration instead of reusing the first configuration.

The reuse indication may, for example, include a bit that may be set in a message from the base station to the NCR or a value inserted into a message from the base station to the NCR.

For example, the base station may store the first configuration for a predetermined time period after the RLF. Upon receiving the connection re-establishment request message from the NCR that indicates an RLF as re-establishment cause, the base station may determine that the base station has the first configuration stored and may include the reuse indication in the connection re-establishment message.

In some embodiments, the first configuration includes at least one of a beam configuration, an on/off configuration and a time division multiplexing configuration, as described above in more detail.

In some embodiments, the first configuration corresponds to a forwarding function of the NCR, e.g., to the NCR-Fwd.

In some embodiments, the detecting of the RLF is based on an RLF timer of the NCR, wherein the RLF timer is configured to indicate the RLF after a shorter duration than an RLF timer of a UE connected to the NCR via the forwarding function.

For example, in order to avoid all UEs under NCR performing re-establishment, an RLF timer for the NCR-MT may be smaller than for normal UEs so that the NCR declares an RLF before the UEs. If the NCR selects the same cell as before the RLF, then an RLF may be avoided for multiple UEs. In some embodiments, this is a network-specific implementation and has no impact on 3GPP or other mobile telecommunication standard specifications.

In some embodiments, the reuse indication is included in a connection re-establishment message. The connection re-establishment message may include an RRCReestablishment message transmitted from the base station to the NCR-MT in response to the connection re-establishment request message.

For example, the network may send an RRC Re-establishment message with the information that the NCR-MT and/or the NCR-Fwd should continue to use its previous configuration (i.e., the first configuration), if the old and new serving cells are the same. The NCR-MT may then resume the suspended (i.e., released) configuration and the NCR may configure the NCR-MT and/or the NCR-Fwd according to the first configuration. If such indication is not received in a Re-establishment message, then the NCR-MT may continue with legacy re-establishment procedure.

In some embodiments, the circuitry is further configured to connect to the base station based on the first configuration if the NCR receives the connection re-establishment message with the reuse indication. For example, the NCR may connect to the base station based on the first configuration upon receiving the connection re-establishment message with the reuse indication without expecting further configuration from the base station.

In some embodiments, the circuitry is further configured to transmit, in response to the connection re-establishment message with the reuse indication, a connection re-establishment complete message to the base station. The connection re-establishment complete message may include an RRCReestablishmentComplete message. The connection re-establishment complete message may indicate to the base station that the NCR has received the reuse indication and/or that the NCR is connecting to the base station based on the first configuration.

In some embodiments, the circuitry is further configured to transmit, in response to the connection re-establishment message with the reuse indication, a connection reconfiguration complete message to the base station. The connection reconfiguration complete message may include an RRCReconfigurationComplete message. For example, the NCR may transmit the connection reconfiguration complete message instead of a connection re-establishment complete message (and without receiving a connection reconfiguration message such as an RRCReconfiguration message) for indicating to the base station that the NCR reuses the first configuration and that the base station need not transmit any further configuration.

In some embodiments, the circuitry is further configured to determine that a connection re-establishment message received from the base station does not include the reuse indication; and transmit a connection re-establishment complete message to the base station. The connection re-establishment message may include an RRCReestablishment message, and the connection re-establishment complete message may include an RRCReestablishmentComplete message.

For example, the base station may transmit a connection re-establishment message without reuse indication if the base station has not stored the first configuration.

For example, one problem may be that the network may have deleted a context of the NCR for e.g. the case where the NCR comes back after few hours (e.g., the NCR may be used for a busy hour only). In this case, the network may not send the reuse indication mentioned above in a connection re-establishment message.

For example, the connection re-establishment complete message may indicate to the base station that the NCR has not received a reuse indication and/or that the NCR expects further configuration from the base station.

In some embodiments, the circuitry is further configured to receive, from the base station, in response to the connection re-establishment complete message, a connection reconfiguration message that indicates a second configuration for connecting to the base station. The connection reconfiguration message may include an RRCReconfiguration message.

In some embodiments, the circuitry is further configured to receive from the base station in response to the connection re-establishment request message a connection reconfiguration message instead of a connection re-establishment message; wherein the connection reconfiguration message indicates a second configuration for connecting to the base station. The connection reconfiguration message may include an RRCReconfiguration message, and the connection re-establishment message may include an RRCReestablishment message.

For example, contents of an RRC re-establishment message may be skipped and instead a reconfiguration message may be sent.

Thus, the NCR-MT may receive the second configuration earlier than if an RRC Re-establishment message and an RRC Re-establishment Complete message were transmitted.

In some embodiments, the circuitry is further configured to trust the base station; and perform further security procedure after connecting to the base station based on the second configuration.

For example, an RRC Re-establishment message may be needed for security (mutual authentication). However, if the NCR selects the same cell as before the RLF or a cell provided by the (same) base station, the base station (e.g., a gNB) and the NCR may trust each other. Additional security procedure may take place later as it may be critical to resume a UE communication (e.g., a forwarding, by the NCR-Fwd, of communication between one or more UEs and the base station) first.

In some embodiments, the second configuration includes at least one of a beam configuration, an on/off configuration and a time division multiplexing configuration. For example, the second configuration may configure similar aspects as the first configuration.

The NCR-MT enhancements described above may also apply, in some embodiments, to normal UEs and may be supported by UEs implementing Rel-18 or later. In such embodiments, the first configuration and/or the second configuration may, for example, include a configuration how the UE connects to the base station. Further, in such embodiments, an indication of an RLF of the UE as re-establishment cause may indicate that the UE has not deleted a configuration of a previous connection that has been interrupted by the RLF and is prepared for reconnecting based on the configuration of the previous connection.

Accordingly, some embodiments pertain to a user equipment (UE) for a mobile telecommunications network, wherein the UE includes circuitry that is configured to detect an RLF in a connection between the UE and a cell provided by a base station of the mobile telecommunications network; and transmit, to the base station, a connection re-establishment request message that includes an indication of an RLF of the user equipment as re-establishment cause. In some embodiments, the circuitry is further configured to perform a cell selection in response to the detected RLF; and determine that a cell selected in the cell selection is provided by the base station. In some embodiments, the determining is based on a cell identifier of the selected cell. In some embodiments, the circuitry is further configured to receive, from the base station, a reuse indication for connecting to the base station based on a first configuration of the connection in which the RLF has been detected. In some embodiments, the first configuration includes at least one of a beam configuration, an on/off configuration and a time division multiplexing configuration. In some embodiments, the reuse indication is included in a connection re-establishment message. In some embodiments, the circuitry is further configured to connect to the base station based on the first configuration if the UE receives the connection re-establishment message with the reuse indication. In some embodiments, the circuitry is further configured to transmit, in response to the connection re-establishment message with the reuse indication, a connection re-establishment complete message to the base station. In some embodiments, the circuitry is further configured to transmit, in response to the connection re-establishment message with the reuse indication, a connection reconfiguration complete message to the base station. In some embodiments, the circuitry is further configured to determine that a connection re-establishment message received from the base station does not include the reuse indication; and transmit a connection re-establishment complete message to the base station. In some embodiments, the circuitry is further configured to receive, from the base station, in response to the connection re-establishment complete message, a connection reconfiguration message that indicates a second configuration for connecting to the base station. In some embodiments, the circuitry is further configured to receive from the base station in response to the connection re-establishment request message a connection reconfiguration message instead of a connection re-establishment message; wherein the connection reconfiguration message indicates a second configuration for connecting to the base station. In some embodiments, the circuitry is further configured to trust the base station; and perform further security procedure after connecting to the base station based on the second configuration. In some embodiments, the second configuration includes at least one of a beam configuration, an on/off configuration and a time division multiplexing configuration.

Accordingly, some embodiments pertain to a base station for a mobile telecommunications network, wherein the base station includes circuitry that is configured to detect an RLF in a connection between a network entity of the mobile telecommunications network and a cell provided by the base station; and receive, from the network entity, a connection re-establishment request message that includes an indication of an RLF of the network entity as re-establishment cause. In some embodiments, the network entity includes at least one of an NCR and a UE. In some embodiments, the circuitry is further configured to transmit, to the network entity, a reuse indication for connecting to the base station based on a first configuration of the connection in which the RLF has been detected. In some embodiments, the circuitry is configured to transmit the reuse indication if the base station holds a context associated with the network entity. In some embodiments, the first configuration includes at least one of a beam configuration, an on/off configuration and a time division multiplexing configuration. In some embodiments, the network entity includes an NCR; and the first configuration corresponds to a forwarding function of the NCR. In some embodiments, the base station is further configured to configure, for an RLF timer of the NCR, a shorter duration for detecting an RLF than for an RLF timer of a UE connected to the NCR via the forwarding function. In some embodiments, the reuse indication is included in a connection re-establishment message. In some embodiments, the circuitry is further configured to receive, in response to the connection re-establishment message with the reuse indication, a connection re-establishment complete message from the network entity. In some embodiments, the circuitry is further configured to receive, in response to the connection re-establishment message with the reuse indication, a connection reconfiguration complete message from the network entity. In some embodiments, the circuitry is further configured to receive, in response to transmitting to the network entity a connection re-establishment message that does not include the reuse indication, a connection re-establishment complete message from the network entity. In some embodiments, the circuitry is further configured to transmit, to the network entity, in response to the connection re-establishment complete message, a connection reconfiguration message that indicates a second configuration for connecting to the base station. In some embodiments, the circuitry is further configured to transmit to the network entity in response to the connection re-establishment request message a connection reconfiguration message instead of a connection re-establishment message; wherein the connection reconfiguration message indicates a second configuration for connecting to the base station. In some embodiments, the circuitry is further configured to trust the network entity; and perform further security procedure after the network entity has connected to the base station based on the second configuration. In some embodiments, the second configuration includes at least one of a beam configuration, an on/off configuration and a time division multiplexing configuration.

Accordingly, some embodiments pertain to a method for a mobile telecommunications network, wherein the mobile telecommunications network includes a base station and a network entity; wherein the method includes detecting an RLF in a connection between the network entity and a cell provided by the base station; and transmitting, from the network entity to the base station, a connection re-establishment request message that includes an indication of an RLF of the network entity as re-establishment cause. In some embodiments, the network entity includes at least one of an NCR and a UE. In some embodiments, the method further includes performing a cell selection in response to the detected RLF; and determining that a cell selected in the cell selection is provided by the base station. In some embodiments, the determining is based on a cell identifier of the selected cell. In some embodiments, the method further includes transmitting, from the base station to the network entity, a reuse indication for connecting to the base station based on a first configuration of the connection in which the RLF has been detected. In some embodiments, the base station transmits the reuse indication if the base station holds a context associated with the network entity. In some embodiments, the first configuration includes at least one of a beam configuration, an on/off configuration and a time division multiplexing configuration. In some embodiments, the network entity includes an NCR; and the first configuration corresponds to a forwarding function of the NCR. In some embodiments, the detecting, by the NCR, of the RLF is based on an RLF timer of the NCR, wherein the RLF timer is configured to indicate the RLF after a shorter duration than an RLF timer of a UE connected to the NCR via the forwarding function. In some embodiments, the method further includes configuring, by the base station, for the RLF timer of the NCR, the shorter duration for detecting an RLF than for the RLF timer of the UE. In some embodiments, the reuse indication is included in a connection re-establishment message. In some embodiments, the method further includes connecting to the base station based on the first configuration if the network entity receives the connection re-establishment message with the reuse indication. In some embodiments, the method further includes transmitting, in response to the connection re-establishment message with the reuse indication, a connection re-establishment complete message from the network entity to the base station. In some embodiments, the method further includes transmitting, in response to the connection re-establishment message with the reuse indication, a connection reconfiguration complete message from the network entity to the base station. In some embodiments, the method further includes determining that a connection re-establishment message received by the network entity from the base station does not include the reuse indication; and transmitting a connection re-establishment complete message from the network entity to the base station. In some embodiments, the method further includes transmitting, from the base station to the network entity, in response to the connection re-establishment complete message, a connection reconfiguration message that indicates a second configuration for connecting to the base station. In some embodiments, the method further includes transmitting from the base station to the network entity in response to the connection re-establishment request message a connection reconfiguration message instead of a connection re-establishment message; wherein the connection reconfiguration message indicates a second configuration for connecting to the base station. In some embodiments, the method further includes trusting the network entity and the base station; and performing further security procedure after connecting, by the network entity, to the base station based on the second configuration. In some embodiments, the second configuration includes at least one of a beam configuration, an on/off configuration and a time division multiplexing configuration.

Accordingly, some embodiments pertain to a mobile telecommunications system that includes a base station as described above; and at least one of an NCR as described above and a UE as described above; wherein the circuitry of the base station and the circuitry of the at least one of the NCR and the UE are configured to perform a method as described above.

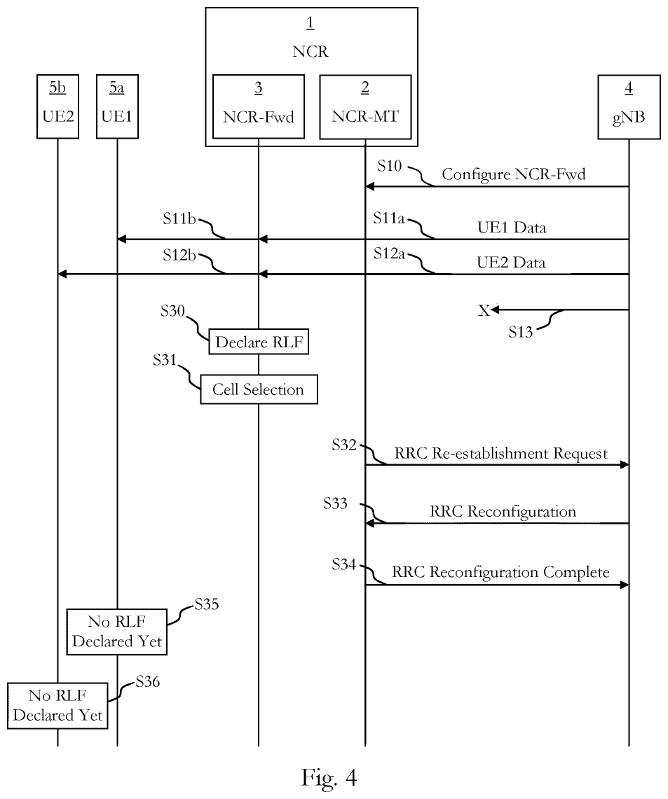

FIG. 4 illustrates a third method for a mobile telecommunications system according to an embodiment. The processing from S10 to S13 corresponds to S10 to S13 of the methods of FIG. 2 and FIG. 3 and, thus, is not discussed again with respect to FIG. 4 for brevity.

At S30, the NCR-Fwd 3 detects and declares an RLF, similar to S14 of the methods of FIG. 2 and FIG. 3. However, at S30, an RLF timer of the NCR 1 is configured to detect an RLF after a shorter duration than RLF timers of the UEs 5a and 5b. Thus, at S30, the NCR 1 detects the RLF before the UE1 5a and the UE2 5b would detect an RLF.

At S31, the NCR-Fwd 3 performs a cell selection similar to the cell selection at S15 of the methods of FIG. 2 and FIG. 3. In some embodiments, at S31, the NCR-Fwd 3 releases or deletes its configuration during or after the cell selection.

The NCR 1 determines, based on a comparison of a CellIdentity, which is an example of a cell identifier, that the cell selected at S31 is the same cell to which the NCR 1 has been connected before the RLF and to which a connection has been interrupted by the RLF.

Thus, at S32, the NCR-MT 2 transmits an RRC Re-establishment Request message to the gNB 4 for requesting a re-establishment of the connection that has been interrupted by the RLF. The RRC Re-establishment Request message is an example of a connection re-establishment request message. In some embodiments, the RRC Re-establishment Request message also includes an indication that indicates an RLF as re-establishment cause.

The gNB 4 determines, based on the RRC Re-establishment Request message and on data associated with the connection that has been interrupted by the RLF, that the NCR 1 is able to recover from the RLF quickly.

At S33, the gNB 4 transmits to the NCR-MT 2 an RRC Reconfiguration message including a configuration for connecting to the gNB 4. The RRC Reconfiguration message is an example of a connection reconfiguration message.

The NCR 1 and the gNB 4 hold data regarding a security of the connection that has been interrupted by the RLF, e.g., data related to a mutual authentication of the NCR 1 and the gNB 4.

Therefore, for a faster recovering from the RLF, the NCR 1 and the gNB 4 trust each other, based on the stored data regarding a security of the connection that has been interrupted by the RLF, and an RRC Re-establishment message and an RRC Re-establishment Complete message are skipped.

The NCR-MT 2 receives the RRC Reconfiguration message and applies a configuration indicated in the RRC Reconfiguration message.

At S34, the NCR-MT 2 transmits an RRC Reconfiguration Complete message to the gNB 4. The RRC Reconfiguration Complete message is an example of a connection reconfiguration complete message.

After transmitting the RRC Reconfiguration Complete message, the NCR 1 is readily connected to the gNB 4, and a forwarding function of the NCR-Fwd 3 is resumed.

Thus, at S35 and S36, the UE1 5a and the UE2 5b, respectively, have not detected or declared an RLF yet and can communicate with the gNB 4 via the access link 8, the NCR-Fwd 3 and the backhaul link 7.

Because the RLF timer of the NCR 1 indicates an RLF after a shorter duration than RLF timers of the UE1 5a and the UE2 5b connected to the gNB 4 via the NCR-Fwd 3, the NCR 1 can reconnect to the gNB 4 and resume the forwarding function of the NCR-Fwd 3 before the RLF timers of the UE1 5a and the UE2 5b detect an RLF.

Thus, communication between the UE1 5a or UE2 5b and the gNB 4 can be continued after the RLF at the backhaul link 7 without performing a connection re-establishment and reconfiguration procedure for the UE1 5a or the UE2 5b.

Further security procedure that has been skipped by skipping an RRC Re-establishment message and an RRC Re-establishment Complete message is, in some embodiments, performed after the RRC Reconfiguration Complete message at S34, when the forwarding function of the NCR-Fwd 3 is resumed.

In some embodiments, the NCR 2, the gNB 4 and the UEs 5a and 5b, respectively, include circuitry configured to perform the method of FIG. 4, as described above.

However, the disclosure is not limited to an NCR. The improved recovering from an RLF according to the present disclosure can be applied to a connection between a base station and any network entity, e.g., an NCR or a UE.

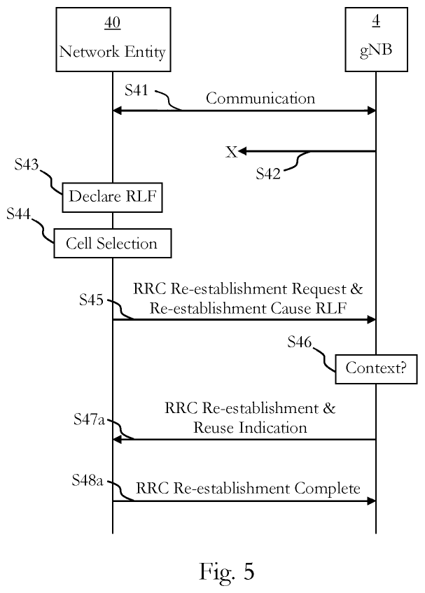

FIG. 5 illustrates a fourth method for a mobile telecommunications system according to an embodiment. The mobile telecommunications system includes a gNB 4, which is an example of a base station, and a network entity 40.

The gNB 4 provides a 5G cell according to New Radio (NR). The network entity 40 may include any entity that is capable of connecting to the 5G cell and of communicating with the gNB 4 according to NR. In some embodiments, the network entity 40 includes an NCR that is connected to the gNB 4 via a control link and that forwards communication between the gNB 4 and another network entity via a backhaul link and an access link. For example, the network entity 40 may include the NCR 1 of FIG. 1 to 4. In some embodiments, the network entity 40 includes a UE that is connected to the gNB 4 directly or via an NCR. For example, the network entity 40 may include the UE 5 of FIG. 1, the UE1 5a of FIG. 2 to 4 and/or the UE2 5b of FIG. 2 to 4. In embodiments, where the network entity includes a UE, or is configured as a UE, implemented or realized as a UE, it can also be a UE. For instance, in some embodiments, the network entity 40 is realized as UE 5 of FIG. 1, the UE1 5a of FIG. 2 to 4 and/or the UE2 5b of FIG. 2 to 4.

At S41, the network entity 40 and the gNB 4 are connected to each other and communicate with each other. The connection is based on a configuration that has been transmitted from the gNB 4 to the network entity 40.

At S42, an RLF occurs. The network entity 40 and the gNB 4 cannot communicate to each other anymore.

At S43, the network entity 40 detects and declares an RLF similar to S14 of the methods of FIG. 2 and FIG. 3 and to S30 of the method of FIG. 4.

At S44, the network entity 40 performs a cell selection similar to S30 of the method of FIG. 4, and determines, based on a comparison of a CellIdentity, which is an example of a cell identifier, that the cell selected in the cell selection is the same cell to which the network entity 40 has been connected before the RLF occurred.

The network entity 40 does not delete its configuration at S44. Instead, the network entity 40 keeps its configuration or, in some embodiments, releases its configuration without deleting it.

At S45, the network entity 40 transmits an RRC Re-establishment Request message to the gNB 4 for requesting a re-establishment of the connection that has been interrupted by the RLF. The RRC Re-establishment Request message is an example of a connection re-establishment request message. The RRC Re-establishment Request message also includes an indication that indicates an RLF as re-establishment cause.

The gNB 4 receives the RRC Re-establishment Request with the indication that indicates an RLF as re-establishment cause. The gNB 4 determines, based on the indication, that the RLF was only temporary and that the network entity 40 is able to recover from the RLF quickly because the network entity 40 has not deleted its configuration.

At S46, the gNB 4 determines whether a context associated with the connection to the network entity 40 is still available or has been deleted already, whether the network entity 40 is an NCR-MT and whether the network entity 40 is a UE.

After the RLF, the gNB 4 releases the context associated with the connection to the network entity 40, but does not delete the context for a predetermined time period. Thus, the gNB 4 finds the context if the gNB 4 receives the RRC Re-establishment Request message within the predetermined time period. This is the case in FIG. 5.

In some embodiments, a release timer of the gNB 4 indicates to release the configuration of the network entity 40 or the context associated with the network entity 40 after a time period that is equal to a duration of an RLF timer of the network entity 40.

At S47a, the gNB 4 transmits an RRC Re-establishment message to the network entity 40. The RRC Re-establishment message is an example of a connection re-establishment message. The RRC Re-establishment message includes a reuse indication that indicates that the network entity 40 should reuse a configuration of the connection that has been interrupted by the RLF.

The network entity 40 receives the RRC Re-establishment message and extracts the reuse indication. Based on the reuse indication, the network entity 40 applies the configuration of the connection that has been interrupted by the RLF.

In embodiments where the network entity 40 has released the configuration of the connection to the gNB 4, the network entity 40 reactivates the released configuration. In some embodiments where the network entity 40 includes an NCR such as the NCR 1 of FIG. 1 to 4, the configuration includes a configuration of a forwarding function of the NCR, such as the NCR-Fwd 3 of FIG. 1 to 4.

At S48a, the network entity 40 transmits an RRC Re-establishment Complete message to the gNB 4. The RRC Re-establishment Complete message is an example of a connection re-establishment complete message. The RRC Re-establishment Complete message indicates to the gNB 4 that the network entity 40 is configured according to the reused configuration of the connection that has been interrupted by the RLF, and that the network entity 40 does not expect any further configuration.

In some embodiments, if the RRC Re-establishment message at S47a does not include the reuse indication, a legacy reconfiguration procedure is performed, e.g., the gNB 4 transmits, after receiving the RRC Re-establishment Complete message, to the network entity 40 an RRC Reconfiguration message including a configuration for connecting to the gNB 4, and the network entity 40 transmits, after receiving the RRC Reconfiguration message, to the gNB 4 an RRC Reconfiguration Complete message.

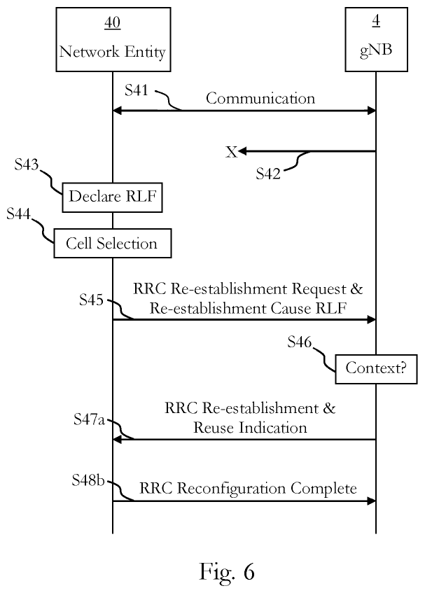

FIG. 6 illustrates a fifth method for a mobile telecommunications system according to an embodiment. S41 to S47a of FIG. 6 correspond to S41 to S47a of FIG. 5; thus, a description thereof is not repeated for brevity. The method of FIG. 6 differs from the method of FIG. 5 by the performing at S48b instead of S48a.

At S48b, the network entity 40 transmits to the gNB 4 an RRC Reconfiguration Complete message. The RRC Reconfiguration Complete message is an example of a connection reconfiguration complete message. The RRC Reconfiguration Complete message indicates to the gNB 4 that the network entity 40 has received the reuse indication from S47a, that the network entity 40 is configured according to the reused configuration of the connection that has been interrupted by the RLF, and that the network entity 40 does not expect any further configuration. Thus, an RRC Re-establishment Complete message and an RRC Reconfiguration message are skipped for a faster recovering from the RLF.

In some embodiments, if the RRC Re-establishment message at S47a does not include the reuse indication, a legacy re-establishment and reconfiguration procedure is performed, e.g., the network entity 40 transmits at S48b, instead of the RRC Reconfiguration Complete message, to the gNB 4 an RRC Re-establishment Complete message, the gNB 4 transmits, after receiving the RRC Re-establishment Complete message, to the network entity 40 an RRC Reconfiguration message including a configuration for connecting to the gNB 4, and the network entity 40 transmits, after receiving the RRC Reconfiguration message, to the gNB 4 an RRC Reconfiguration Complete message.

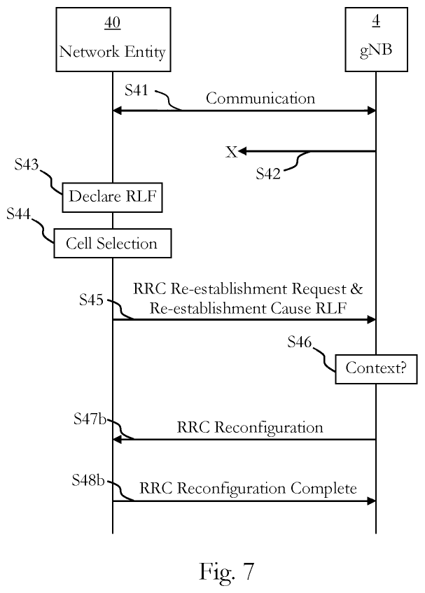

FIG. 7 illustrates a sixth method for a mobile telecommunications system according to an embodiment. S41 to S46 of FIG. 7 correspond to S41 to S46 of FIG. 5 and FIG. 6; thus, a description thereof is not repeated for brevity. The method of FIG. 7 differs from the method of FIG. 6 by the performing at S47b instead of S47a.

At S47b, the gNB 4 transmits to the network entity 40 an RRC Reconfiguration message. The RRC Reconfiguration message is an example of a connection reconfiguration message. If the gNB 4 finds a context associated with the connection to the network entity 40 at S46 (which is the case in FIG. 7), the gNB 4 skips an RRC Re-establishment message and an RRC Re-establishment Complete message and transmits a configuration in the RRC Reconfiguration message. In a case where the configuration of the connection that has been interrupted by the RLF is not appropriate anymore, the RRC Reconfiguration message includes a new configuration for connecting to the gNB 4. In a case where the configuration of the connection that has been interrupted by the RLF is still appropriate, the RRC Reconfiguration message includes the configuration of the interrupted connection or, in some embodiments, a reuse indication that indicates to the network entity 40 that the configuration of the interrupted connection should be reused.

The network entity 40 receives the RRC Reconfiguration message and applies the configuration included or indicated in the RRC Reconfiguration message.

At S48b, the network entity 40 transmits to the gNB 4 an RRC Reconfiguration Complete message similar to S48b of FIG. 6. However, if the RRC Reconfiguration message of S47b includes a new configuration different from a configuration of the interrupted connection, the RRC Reconfiguration Complete message indicates to the gNB 4 that the network entity 40 is configured according to the new configuration.

In some embodiments, if the gNB 4 does not find a context associated with the connection to the network entity 40 at S46, a legacy re-establishment and reconfiguration procedure is performed, e.g., the gNB 4 transmits, before the RRC Reconfiguration message at S47b, to the network entity 40 an RRC Re-establishment message, the network entity 40 transmits, after receiving the RRC Re-establishment message and before the RRC Reconfiguration message at S47b, to the gNB 4 an RRC Re-establishment Complete message, and the gNB 4 transmits the RRC Reconfiguration message at S47b only after receiving the RRC Re-establishment Complete message.

In some embodiments, a base station, such as the gNB 4 of FIG. 1 to 7, includes circuitry configured to perform at least one of the methods of FIG. 5 to 7. In some embodiments, a network entity, such as the network entity 40 of FIG. 5 to 7, includes circuitry configured to perform at least one of the methods of FIG. 5 to 7. In some embodiments, the network entity, that includes circuitry configured to perform at least one of the methods of FIG. 5 to 7, includes a user equipment that may be directly connected to the base station or that may be connected to the base station via an NCR, such as the UE 5 of FIG. 1 and/or the UE1 5a and UE2 5b of FIG. 2 to 4. In some embodiments, the network entity, that is configured to perform at least one of the methods of FIG. 5 to 7, includes an NCR, such as the NCR 1 of FIG. 1 to 4.

In some embodiments, the UE1 5a and/or the UE2 5b of FIG. 2 and FIG. 3 performs, instead of the cell selection at S22 and/or S24, respectively, the cell selection at S44 of FIG. 5 to FIG. 7, and performs, instead of the re-establishment/reconfiguration procedure at S25 and/or S26, respectively, one of the methods of FIG. 5 to FIG. 7 for reconnecting to the gNB 4.

FIG. 8 illustrates a user equipment (UE), a network-controlled repeater (NCR) and a base station (BS) according to an embodiment.

An embodiment of a UE 90 according to the present disclosure (which can also be implemented as the network entity discussed herein), an NCR 92 according to the present disclosure (which can also be implemented as the network entity discussed herein), a base station (BS) 95 according to the present disclosure (e.g. NR eNB/gNB), a communication path 104 between the UE 90 and the NCR 92, and a communication path 108 between the NCR 92 and the BS 95, which are used for implementing embodiments of the present disclosure, is discussed under reference of FIG. 8.

The UE 90 has a transmitter 101, a receiver 102 and a controller 103, wherein, generally, the technical functionality of the transmitter 101, the receiver 102 and the controller 103 are known to the skilled person, and, thus, a more detailed description of these elements is omitted.

The NCR 92 has a transmitter 105, a receiver 106 and a controller 107, wherein, generally, the technical functionality of the transmitter 105, the receiver 106 and the controller 107 are known to the skilled person, and, thus, a more detailed description of these elements is omitted.

The BS 95 has a transmitter 109, a receiver 110 and a controller 111, wherein also here, generally, the functionality of the transmitter 109, the receiver 110 and the controller 111 are known to the skilled person, and, thus, a more detailed description of these elements is omitted.

The communication path 104 has an uplink path 104a, which is from the UE 90 to the NCR 92, and a downlink path 104b, which is from the NCR 92 to the UE 90. The communication path 104 includes an access link according to the present disclosure.

The communication path 108 has an uplink path 108a, which is from the NCR 92 to the BS 95, and a downlink path 108b, which is from the BS 95 to the NCR 92. The communication path 108 includes a control link and a backhaul link according to the present disclosure.

During operation, the controller 103 of the UE 90 controls the reception of downlink signals over the downlink path 104b at the receiver 102 and the controller 103 controls the transmission of uplink signals over the uplink path 104a via the transmitter 101.

Similarly, during operation, the controller 107 of the NCR 92 controls the reception of uplink signals over the uplink path 104a and of downlink signals over the downlink path 108b at the receiver 106 and the controller 107 controls the transmission of downlink signals over the downlink path 104b and of uplink signals over the uplink path 108a via the transmitter 105.

Similarly, during operation, the controller 111 of the BS 95 controls the transmission of downlink signals over the downlink path 108b at the transmitter 109 and the controller 111 controls the reception of uplink signals over the uplink path 108a at the receiver 110.

It is noted that, in some embodiments, the UE 90 is directly connected to the BS 95 without the NCR 92 in between. In such a case, the communication path 104 and the communication path 108 coincide.

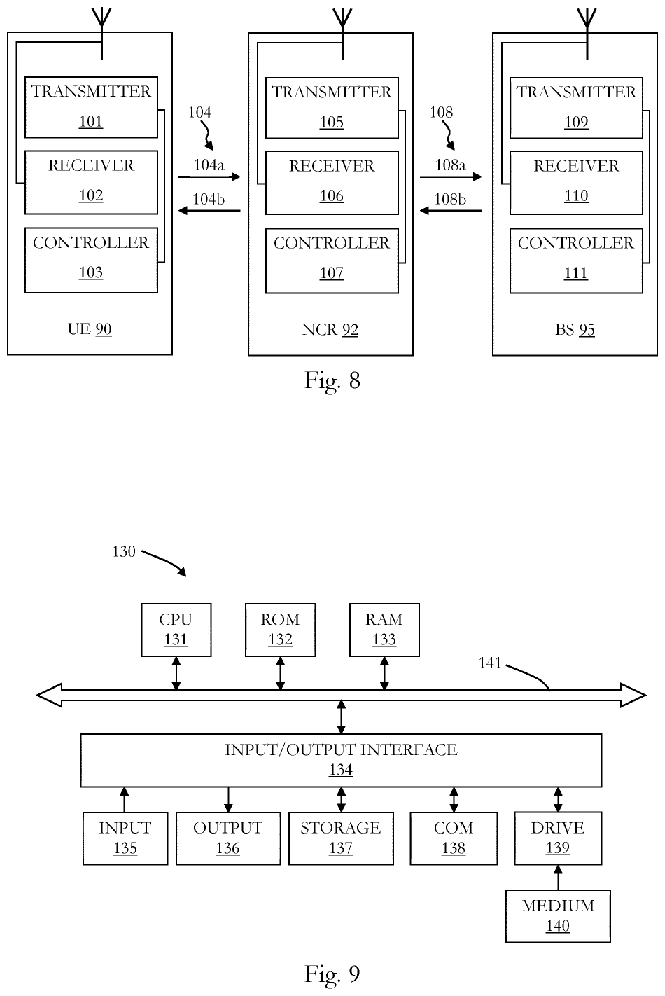

In the following, an embodiment of a general purpose computer 130 is described under reference of FIG. 9, which illustrates a general purpose computer according to an embodiment.

The computer 130 can be implemented such that it can basically function as any type of user equipment, network-controlled repeater, base station or new radio base station, transmission and reception point, or network entity, as discussed herein. The computer has components 131 to 141, which can form circuitry, such as any one of the circuitries of the network-controlled repeater, base station, network entity and user equipment, and the like, as described herein.

Embodiments which use software, firmware, programs or the like for performing the methods as described herein can be installed on computer 130, which is then configured to be suitable for the particular embodiment.

The computer 130 has a CPU 131 (Central Processing Unit), which can execute various types of procedures and methods as described herein, for example, in accordance with programs stored in a read-only memory (ROM) 132, stored in a storage 137 and loaded into a random access memory (RAM) 133, stored on a medium 140 which can be inserted in a respective drive 139, etc.

The CPU 131, the ROM 132 and the RAM 133 are connected with a bus 141, which in turn is connected to an input/output interface 134. The number of CPUs, memories and storages is only exemplary, and the skilled person will appreciate that the computer 130 can be adapted and configured accordingly for meeting specific requirements which arise, when it functions as a network-controlled repeater, base station, network entity or user equipment.

At the input/output interface 134, several components are connected: an input 135, an output 136, the storage 137, a communication interface 138 and the drive 139, into which a medium 140 (compact disc, digital video disc, compact flash memory, or the like) can be inserted.

The input 135 can be a pointer device (mouse, graphic table, or the like), a keyboard, a microphone, a camera, a touchscreen, etc.

The output 136 can have a display (liquid crystal display, cathode ray tube display, light emittance diode display, electronic ink, etc.), loudspeakers, etc.

The storage 137 can have a hard disk, a solid state drive and the like.

The communication interface 138 can be adapted to communicate, for example, via a local area network (LAN), wireless local area network (WLAN), mobile telecommunications system (GSM, UMTS, LTE, NR etc.), Bluetooth, infrared, near-field communication, etc.

It should be noted that the description above only pertains to an example configuration of computer 130. Alternative configurations may be implemented with additional or other sensors, storage devices, interfaces or the like. For example, the communication interface 138 may support other radio access technologies than UMTS, LTE and NR, or the like.

When the computer 130 functions as a base station, the communication interface 138 can further have a respective air interface (providing e.g. E-UTRA protocols OFDMA (downlink) and SC-FDMA (uplink)) and network interfaces (implementing for example protocols such as S1-AP, GTP-U, S1-MME, X2-AP, or the like). The computer 130 is also implemented to transmit data in accordance with TCP. Moreover, the computer 130 may have one or more antennas and/or an antenna array. The present disclosure is not limited to any particularities of such protocols.

The methods as described herein are also implemented in some embodiments as a computer program causing a computer and/or a processor to perform the method, when being carried out on the computer and/or processor. In some embodiments, also a non-transitory computer-readable recording medium is provided that stores therein a computer program product, which, when executed by a processor, such as the processor described above, causes the methods described herein to be performed.

It should be recognized that the embodiments describe methods with an exemplary ordering of method steps. The specific ordering of method steps is however given for illustrative purposes only and should not be construed as binding. For example, the ordering of S11a/S11b and S12a/S12b in the embodiment of FIG. 2 to FIG. 4 may be exchanged. Also, the ordering of S21/S22 and S23/S24 in the embodiment of FIG. 2 and FIG. 3 may be exchanged. Further, also the ordering of S25 and S26 in the embodiment of FIG. 2 and FIG. 3 may be exchanged. Other changes of the ordering of method steps may be apparent to the skilled person.

In so far as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure.

Note that the present technology can also be configured as described below.

(A1) A network-controlled repeater for a mobile telecommunications network, wherein the network-controlled repeater comprises circuitry configured to:
detect a radio link failure in a connection between the network-controlled repeater and a cell provided by a base station of the mobile telecommunications network; and
release, based on the detected radio link failure, a first configuration of a forwarding function of the network-controlled repeater.

(A2) The network-controlled repeater of (A1), wherein the releasing of the first configuration includes deleting the first configuration.

(A3) The network-controlled repeater of (A1) or (A2), wherein the first configuration includes at least one of a beam configuration, an on/off configuration and a time division multiplexing configuration.

(A4) The network-controlled repeater of any one of (A1) to (A3), wherein the circuitry is configured to release the first configuration for accepting a second configuration of the forwarding function.

(A5) The network-controlled repeater of (A4), wherein the second configuration includes at least one of a beam configuration, an on/off configuration and a time division multiplexing configuration.

(A6) The network-controlled repeater of (A4) or (A5), wherein the circuitry is further configured to:
perform a cell selection in response to the detected radio link failure; and
determine that a cell selected in the cell selection is provided by the base station.

(A7) The network-controlled repeater of (A6), wherein the determining is based on a cell identifier of the selected cell.

(A8) The network-controlled repeater of (A6) or (A7), wherein the circuitry is further configured to transmit a connection re-establishment request message to the base station.

(A9) The network-controlled repeater of (A8), wherein the circuitry is further configured to receive the second configuration from the base station.

(A10) The network-controlled repeater of (A9), wherein the circuitry is further configured to request the second configuration from the base station.

(A11) The network-controlled repeater of (A10), wherein the requesting includes transmitting a request of the second configuration in the connection re-establishment request message.

(A12) The network-controlled repeater of (A10) or (A11), wherein the requesting includes transmitting a request of the second configuration in a connection re-establishment complete message.

(A13) The network-controlled repeater of any one of (A9) to (A11), wherein the receiving includes receiving the second configuration in a connection re-establishment message.

(A14) The network-controlled repeater of any one of (A9) to (A13), wherein the receiving includes receiving the second configuration in a connection reconfiguration message.

(A15) The network-controlled repeater of any one of (A8) to (A14), wherein the connection re-establishment request message includes an indication of a radio link failure of the network-controlled repeater as re-establishment cause.

(A16) The network-controlled repeater of any one of (A8) to (A15), wherein the circuitry is further configured to:
receive a connection re-establishment message from the base station; and
determine whether the connection re-establishment message includes a reuse indication for continuing providing the forwarding function based on the first configuration.

(A17) The network-controlled repeater of (A16), wherein the circuitry is further configured to continue providing the forwarding function based on the first configuration if the connection re-establishment message includes the reuse indication.

(A18) The network-controlled repeater of (A16) or (A17), wherein the circuitry is further configured to receive the second configuration if the connection re-establishment message does not include the reuse indication.

(A19) The network-controlled repeater of any one of (A8) to (A15), wherein the circuitry is further configured to receive from the base station in response to the connection re-establishment request message a connection reconfiguration message instead of a connection re-establishment message.

(A20) The network-controlled repeater of (A19), wherein the circuitry is further configured to:
trust the base station; and
perform further security procedure after resuming providing the forwarding function.

(A21) The network-controlled repeater of any one of (A1) to (A20), wherein the detecting of the radio link failure is based on a radio link failure timer of the network-controlled repeater.

(A22) The network-controlled repeater of (A21), wherein the radio link failure timer of the network-controlled repeater is configured to indicate the radio link failure after a shorter duration than a radio link failure timer of a user equipment connected to the network-controlled repeater via the forwarding function.

(B1) A base station for a mobile telecommunications network, wherein the base station comprises circuitry configured to:
detect a radio link failure in a connection between a network-controlled repeater of the mobile telecommunications network and a cell provided by the base station; and
release, based on the detected radio link failure, a first configuration of a forwarding function of the network-controlled repeater.

(B2) The base station of (B1), wherein the releasing of the first configuration includes deleting the first configuration.

(B3) The base station of (B1) or (B2), wherein the first configuration includes at least one of a beam configuration, an on/off configuration and a time division multiplexing configuration.

(B4) The base station of any one of (B1) to (B3), wherein the releasing of the first configuration is based on a release timer of the base station.

(B5) The base station of (B4), wherein the release timer is configured to indicate a release of the first configuration after a time period that corresponds to a duration of a radio link failure timer of the network-controlled repeater.

(B6) The base station of any one of (B1) to (B5), wherein the circuitry is further configured to receive a connection re-establishment request message from the network-controlled repeater.

(B7) The base station of (B6), wherein the circuitry is further configured to provide a second configuration of the forwarding function to the network-controlled repeater.

(B8) The base station of (B7), wherein the second configuration includes at least one of abeam configuration, an on/off configuration and a time division multiplexing configuration.

(B9) The base station of (B7) or (B8), wherein the circuitry is further configured to receive a request of the second configuration from the network-controlled repeater.

(B10) The base station of (B9), wherein the receiving includes receiving the request of the second configuration in the connection re-establishment request message.

(B11) The base station of (B9) or (B10), wherein the receiving includes receiving the request of the second configuration in a connection re-establishment complete message.

(B12) The base station of any one of (B7) to (B10), wherein the providing includes transmitting the second configuration in a connection re-establishment message.

(B13) The base station of any one of (B7) to (B12), wherein the providing includes transmitting the second configuration in a connection reconfiguration message.

(B14) The base station of any one of (B6) to (B13), wherein the connection re-establishment request message includes an indication of a radio link failure of the network-controlled repeater as re-establishment cause.

(B15) The base station of any one of (B6) to (B14), wherein the circuitry is further configured to transmit, in a connection re-establishment message to the network-controlled repeater, a reuse indication for continuing providing the forwarding function based on the first configuration.

(B16) The base station of (B15), wherein the circuitry is configured to transmit the reuse indication if the base station holds a user equipment context of a user equipment connected to the network-controlled repeater according to the first configuration.

(B17) The base station of (B15) or (B16), wherein the circuitry is configured to transmit the reuse indication if the base station holds a network-controlled repeater mobile termination context of the network-controlled repeater according to the first configuration.

(B18) The base station of any one of (B15) to (B17), wherein the circuitry is configured to not transmit the reuse indication if the base station does not hold a user equipment context of a user equipment connected to the network-controlled repeater according to the first configuration.

(B19) The base station of any one of (B15) to (B18), wherein the circuitry is configured to not transmit the reuse indication if the base station does not hold a network-controlled repeater mobile termination context of the network-controlled repeater according to the first configuration.

(B20) The base station of any one of (B6) to (B14), wherein the circuitry is further configured to transmit to the network-controlled repeater in response to the connection re-establishment request message a connection reconfiguration message instead of a connection re-establishment message.

(B21) The base station of (B20), wherein the circuitry is further configured to:
trust the network-controlled repeater; and
perform further security procedure after the network-controlled repeater has resumed providing the forwarding function.

(B22) The base station of any one of (B1) to (B21), wherein the circuitry is further configured to configure, for a radio link failure timer of the network-controlled repeater, a shorter duration for detecting a radio link failure than for a radio link failure timer of a user equipment connected to the network-controlled repeater via the forwarding function.

(C1) A method for a mobile telecommunications network,
wherein the mobile telecommunications network includes a network-controlled repeater and a base station;
wherein the method comprises:
detecting a radio link failure in a connection between the network-controlled repeater and a cell provided by the base station; and
releasing, based on the detected radio link failure, a first configuration of a forwarding function of the network-controlled repeater.

(C2) The method of (C1), wherein the releasing of the first configuration includes deleting the first configuration.

(C3) The method of (C1) or (C2), wherein the first configuration includes at least one of a beam configuration, an on/off configuration and a time division multiplexing configuration.

(C4) The method of any one of (C1) to (C3), wherein the releasing, at the base station, of the first configuration is based on a release timer of the base station.

(C5) The method of (C4), wherein the release timer indicates a release of the first configuration after a time period that corresponds to a duration of a radio link failure timer of the network-controlled repeater.

(C6) The method of any one of (C1) to (C5), wherein the method includes releasing, at the network-controlled repeater, the first configuration for accepting a second configuration of the forwarding function.

(C7) The method of (C6), wherein the second configuration includes at least one of a beam configuration, an on/off configuration and a time division multiplexing configuration.

(C8) The method of (C6) or (C7), further comprising:
performing a cell selection in response to the detected radio link failure; and
determining that a cell selected in the cell selection is provided by the base station.

(C9) The method of (C8), wherein the determining is based on a cell identifier of the selected cell.

(C10) The method of (C8) or (C9), further comprising transmitting a connection re-establishment request message from the network-controlled repeater to the base station.

(C11) The method of (C10), further comprising providing the second configuration from the base station to the network-controlled repeater.

(C12) The method of (C11), further comprising requesting, by the network-controlled repeater, the second configuration from the base station.

(C13) The method of (C12), wherein the requesting includes transmitting a request of the second configuration in the connection re-establishment request message.

(C14) The method of (C12) or (C13), wherein the requesting includes transmitting a request of the second configuration in a connection re-establishment complete message.

(C15) The method of any one of (C11) to (C13), wherein the providing includes transmitting the second configuration in a connection re-establishment message.

(C16) The method of any one of (C11) to (C15), wherein the providing includes transmitting the second configuration in a connection reconfiguration message.

(C17) The method of any one of (C10) to (C16), wherein the connection re-establishment request message includes an indication of a radio link failure of the network-controlled repeater as re-establishment cause.

(C18) The method of any one of (C10) to (C17), further comprising transmitting, in a connection re-establishment message from the base station to the network-controlled repeater, a reuse indication for continuing providing the forwarding function based on the first configuration.

(C19) The method of (C18), wherein the base station transmits the reuse indication if the base station holds a user equipment context of a user equipment connected to the network-controlled repeater according to the first configuration.

(C20) The method of (C18) or (C19), wherein the base station transmits the reuse indication if the base station holds a network-controlled repeater mobile termination context of the network-controlled repeater according to the first configuration.

(C21) The method of any one of (C18) to (C20), wherein the base station does not transmit the reuse indication if the base station does not hold a user equipment context of a user equipment connected to the network-controlled repeater according to the first configuration.

(C22) The method of any one of (C18) to (C21), wherein the base station does not transmit the reuse indication if the base station does not hold a network-controlled repeater mobile termination context of the network-controlled repeater according to the first configuration.

(C23) The method of any one of (C18) to (C22), further comprising continuing, by the network-controlled repeater, providing the forwarding function based on the first configuration if the connection re-establishment message includes the reuse indication.

(C24) The method of any one of (C18) to (C23), further comprising receiving the second configuration if the connection re-establishment message does not include the reuse indication.

(C25) The method of any one of (C10) to (C17), further comprising transmitting from the base station to the network-controlled repeater in response to the connection re-establishment request message a connection reconfiguration message instead of a connection re-establishment message.

(C26) The method of (C25), further comprising:
trusting the network-controlled repeater and the base station; and
performing further security procedure after resuming, by the network-controlled repeater, providing the forwarding function.

(C27) The method of any one of (C1) to (C26), wherein the detecting, by the network-controlled repeater, of the radio link failure is based on a radio link failure timer of the network-controlled repeater.

(C28) The method of (C27), wherein the detecting, by the network-controlled repeater, of the radio link failure includes indicating, by the radio link failure timer of the network-controlled repeater, the radio link failure after a shorter duration than a radio link failure timer of a user equipment connected to the network-controlled repeater via the forwarding function.

(C29) The method of (C28), further comprising configuring, by the base station, for the radio link failure timer of the network-controlled repeater, the shorter duration for detecting a radio link failure than for the radio link failure timer of the user equipment.

(D1) A mobile telecommunications system, comprising:
the network-controlled repeater of any one of (A1) to (A22); and
the base station of any one of (B1) to (B22);
wherein the circuitry of the network-controlled repeater and the circuitry of the base station are configured to perform the method of any one of (C1) to (C29).

(E1) A network-controlled repeater for a mobile telecommunications network, wherein the network-controlled repeater comprises circuitry configured to:
detect a radio link failure in a connection between the network-controlled repeater and a cell provided by a base station of the mobile telecommunications network; and
transmit, to the base station, a connection re-establishment request message that includes an indication of a radio link failure of the network-controlled repeater as re-establishment cause.

(E2) The network-controlled repeater of (E1), wherein the circuitry is further configured to:
perform a cell selection in response to the detected radio link failure; and
determine that a cell selected in the cell selection is provided by the base station.

(E3) The network-controlled repeater of (E2), wherein the determining is based on a cell identifier of the selected cell.

(E4) The network-controlled repeater of any one of (E1) to (E3), wherein the circuitry is further configured to receive, from the base station, a reuse indication for connecting to the base station based on a first configuration of the connection in which the radio link failure has been detected.

(E5) The network-controlled repeater of (E4), wherein the first configuration includes at least one of a beam configuration, an on/off configuration and a time division multiplexing configuration.

(E6) The network-controlled repeater of (E4) or (E5), wherein the first configuration corresponds to a forwarding function of the network-controlled repeater.

(E7) The network-controlled repeater of (E6), wherein the detecting of the radio link failure is based on a radio link failure timer of the network-controlled repeater, wherein the radio link failure timer is configured to indicate the radio link failure after a shorter duration than a radio link failure timer of a user equipment connected to the network-controlled repeater via the forwarding function.

(E8) The network-controlled repeater of any one of (E4) to (E7), wherein the reuse indication is included in a connection re-establishment message.

(E9) The network-controlled repeater of (E8), wherein the circuitry is further configured to connect to the base station based on the first configuration if the network-controlled repeater receives the connection re-establishment message with the reuse indication.

(E10) The network-controlled repeater of (E8) or (E9), wherein the circuitry is further configured to transmit, in response to the connection re-establishment message with the reuse indication, a connection re-establishment complete message to the base station.

(E11) The network-controlled repeater of (E8) or (E9), wherein the circuitry is further configured to transmit, in response to the connection re-establishment message with the reuse indication, a connection reconfiguration complete message to the base station.

(E12) The network-controlled repeater of any one of (E8) to (E11), wherein the circuitry is further configured to:
determine that a connection re-establishment message received from the base station does not include the reuse indication; and
transmit a connection re-establishment complete message to the base station.

(E13) The network-controlled repeater of (E12), wherein the circuitry is further configured to receive, from the base station, in response to the connection re-establishment complete message, a connection reconfiguration message that indicates a second configuration for connecting to the base station.

(E14) The network-controlled repeater of any one of (E1) to (E11), wherein the circuitry is further configured to receive from the base station in response to the connection re-establishment request message a connection reconfiguration message instead of a connection re-establishment message;
wherein the connection reconfiguration message indicates a second configuration for connecting to the base station.

(E15) The network-controlled repeater of (E14), wherein the circuitry is further configured to:
trust the base station; and
perform further security procedure after connecting to the base station based on the second configuration.

(E16) The network-controlled repeater of any one of (E13) to (E15), wherein the second configuration includes at least one of a beam configuration, an on/off configuration and a time division multiplexing configuration.

(F1) A user equipment for a mobile telecommunications network, wherein the user equipment comprises circuitry configured to:
detect a radio link failure in a connection between the user equipment and a cell provided by a base station of the mobile telecommunications network; and
transmit, to the base station, a connection re-establishment request message that includes an indication of a radio link failure of the user equipment as re-establishment cause.

(F2) The user equipment of (F1), wherein the circuitry is further configured to:
perform a cell selection in response to the detected radio link failure; and
determine that a cell selected in the cell selection is provided by the base station.

(F3) The user equipment of (F2), wherein the determining is based on a cell identifier of the selected cell.

(F4) The user equipment of any one of (F1) to (F3), wherein the circuitry is further configured to receive, from the base station, a reuse indication for connecting to the base station based on a first configuration of the connection in which the radio link failure has been detected.

(F5) The user equipment of (F4), wherein the first configuration includes at least one of a beam configuration, an on/off configuration and a time division multiplexing configuration.

(F6) The user equipment of (F4) or (F5), wherein the reuse indication is included in a connection re-establishment message.

(F7) The user equipment of (F6), wherein the circuitry is further configured to connect to the base station based on the first configuration if the user equipment receives the connection re-establishment message with the reuse indication.

(F8) The user equipment of (F6) or (F7), wherein the circuitry is further configured to transmit, in response to the connection re-establishment message with the reuse indication, a connection re-establishment complete message to the base station.

(F9) The user equipment of (F6) or (F7), wherein the circuitry is further configured to transmit, in response to the connection re-establishment message with the reuse indication, a connection reconfiguration complete message to the base station.

(F10) The user equipment of any one of (F6) to (F9), wherein the circuitry is further configured to:
determine that a connection re-establishment message received from the base station does not include the reuse indication; and
transmit a connection re-establishment complete message to the base station.

(F11) The user equipment of (F10), wherein the circuitry is further configured to receive, from the base station, in response to the connection re-establishment complete message, a connection reconfiguration message that indicates a second configuration for connecting to the base station.

(F12) The user equipment of any one of (F1) to (F9), wherein the circuitry is further configured to receive from the base station in response to the connection re-establishment request message a connection reconfiguration message instead of a connection re-establishment message;
wherein the connection reconfiguration message indicates a second configuration for connecting to the base station.

(F13) The user equipment of (F12), wherein the circuitry is further configured to:
trust the base station; and
perform further security procedure after connecting to the base station based on the second configuration.

(F14) The user equipment of any one of (F11) to (F13), wherein the second configuration includes at least one of a beam configuration, an on/off configuration and a time division multiplexing configuration.

(G1) A base station for a mobile telecommunications network, wherein the base station comprises circuitry configured to:
detect a radio link failure in a connection between a network entity of the mobile telecommunications network and a cell provided by the base station; and
receive, from the network entity, a connection re-establishment request message that includes an indication of a radio link failure of the network entity as re-establishment cause.

(G2) The base station of (G1), wherein the network entity includes at least one of a network-controlled repeater and a user equipment.

(G3) The base station of (G1) or (G2), wherein the circuitry is further configured to transmit, to the network entity, a reuse indication for connecting to the base station based on a first configuration of the connection in which the radio link failure has been detected.

(G4) The base station of (G3), wherein the circuitry is configured to transmit the reuse indication if the base station holds a context associated with the network entity.

(G5) The base station of (G3) or (G4), wherein the first configuration includes at least one of a beam configuration, an on/off configuration and a time division multiplexing configuration.

(G6) The base station of any one of (G3) to (G5), wherein the network entity includes a network-controlled repeater; and
wherein the first configuration corresponds to a forwarding function of the network-controlled repeater.

(G7) The base station of (G6), further configured to configure, for a radio link failure timer of the network-controlled repeater, a shorter duration for detecting a radio link failure than for a radio link failure timer of a user equipment connected to the network-controlled repeater via the forwarding function.

(G8) The base station of any one of (G3) to (G7), wherein the reuse indication is included in a connection re-establishment message.

(G9) The base station of (G8), wherein the circuitry is further configured to receive, in response to the connection re-establishment message with the reuse indication, a connection re-establishment complete message from the network entity.

(G10) The base station of (G8), wherein the circuitry is further configured to receive, in response to the connection re-establishment message with the reuse indication, a connection reconfiguration complete message from the network entity.

(G11) The base station of any one of (G8) to (G10), wherein the circuitry is further configured to receive, in response to transmitting to the network entity a connection re-establishment message that does not include the reuse indication, a connection re-establishment complete message from the network entity.

(G12) The base station of (G11), wherein the circuitry is further configured to transmit, to the network entity, in response to the connection re-establishment complete message, a connection reconfiguration message that indicates a second configuration for connecting to the base station.

(G13) The base station of any one of (G1) to (G11), wherein the circuitry is further configured to transmit to the network entity in response to the connection re-establishment request message a connection reconfiguration message instead of a connection re-establishment message;
wherein the connection reconfiguration message indicates a second configuration for connecting to the base station.

(G14) The base station of (G13), wherein the circuitry is further configured to:
trust the network entity; and
perform further security procedure after the network entity has connected to the base station based on the second configuration.

(G15) The base station of any one of (G12) to (G14), wherein the second configuration includes at least one of a beam configuration, an on/off configuration and a time division multiplexing configuration.

(H1) A method for a mobile telecommunications network,
wherein the mobile telecommunications network includes a base station and a network entity;
wherein the method comprises:
detecting a radio link failure in a connection between the network entity and a cell provided by the base station; and
transmitting, from the network entity to the base station, a connection re-establishment request message that includes an indication of a radio link failure of the network entity as re-establishment cause.

(H2) The method of (H1), wherein the network entity includes at least one of a network-controlled repeater and a user equipment.

(H3) The method of (H1) or (H2), further comprising:
performing a cell selection in response to the detected radio link failure; and
determining that a cell selected in the cell selection is provided by the base station.

(H4) The method of (H3), wherein the determining is based on a cell identifier of the selected cell.

(H5) The method of any one of (H1) to (H4), further comprising transmitting, from the base station to the network entity, a reuse indication for connecting to the base station based on a first configuration of the connection in which the radio link failure has been detected.

(H6) The method of (H5), wherein the base station transmits the reuse indication if the base station holds a context associated with the network entity.

(H7) The method of (H5) or (H6), wherein the first configuration includes at least one of a beam configuration, an on/off configuration and a time division multiplexing configuration.

(H8) The method of any one of (H5) to (H7), wherein the network entity includes a network-controlled repeater; and
wherein the first configuration corresponds to a forwarding function of the network-controlled repeater.

(H9) The method of (H8), wherein the detecting, by the network-controlled repeater, of the radio link failure is based on a radio link failure timer of the network-controlled repeater, wherein the radio link failure timer is configured to indicate the radio link failure after a shorter duration than a radio link failure timer of a user equipment connected to the network-controlled repeater via the forwarding function.

(H10) The method of (H9), further comprising configuring, by the base station, for the radio link failure timer of the network-controlled repeater, the shorter duration for detecting a radio link failure than for the radio link failure timer of the user equipment.

(H11) The method of any one of (H5) to (H10), wherein the reuse indication is included in a connection re-establishment message.

(H12) The method of (H11), further comprising connecting to the base station based on the first configuration if the network entity receives the connection re-establishment message with the reuse indication.

(H13) The method of (H11) or (H12), further comprising transmitting, in response to the connection re-establishment message with the reuse indication, a connection re-establishment complete message from the network entity to the base station.

(H14) The method of (H11) or (H12), further comprising transmitting, in response to the connection re-establishment message with the reuse indication, a connection reconfiguration complete message from the network entity to the base station.

(H15) The method of any one of (H11) to (H14), further comprising:
determining that a connection re-establishment message received by the network entity from the base station does not include the reuse indication; and
transmitting a connection re-establishment complete message from the network entity to the base station.

(H16) The method of (H15), further comprising transmitting, from the base station to the network entity, in response to the connection re-establishment complete message, a connection reconfiguration message that indicates a second configuration for connecting to the base station.

(H17) The method of any one of (H1) to (H14), further comprising transmitting from the base station to the network entity in response to the connection re-establishment request message a connection reconfiguration message instead of a connection re-establishment message;
wherein the connection reconfiguration message indicates a second configuration for connecting to the base station.

(H18) The method of (H17), further comprising:
trusting the network entity and the base station; and
performing further security procedure after connecting, by the network entity, to the base station based on the second configuration.

(H19) The method of any one of (H16) to (H18), wherein the second configuration includes at least one of a beam configuration, an on/off configuration and a time division multiplexing configuration.

(I1) A mobile telecommunications system, comprising:
the base station of any one of (G1) to (G15); and
at least one of the network-controlled repeater of any one of (E1) to (E16) and the user equipment of any one of (F1) to (F14);
wherein the circuitry of the base station and the circuitry of the at least one of the network-controlled repeater and the user equipment are configured to perform the method of any one of (H1) to (H19).

1. A network-controlled repeater for a mobile telecommunications network, wherein the network-controlled repeater comprises circuitry configured to:
detect a radio link failure in a connection between the network-controlled repeater and a cell provided by a base station of the mobile telecommunications network; and
release, based on the detected radio link failure, a first configuration of a forwarding function of the network-controlled repeater.

2. The network-controlled repeater of claim 1, wherein the releasing of the first configuration includes deleting the first configuration.

3. The network-controlled repeater of claim 1, wherein the first configuration includes at least one of a beam configuration, an on/off configuration and a time division multiplexing configuration.

4. The network-controlled repeater of claim 1, wherein the circuitry is configured to release the first configuration for accepting a second configuration of the forwarding function.

5. The network-controlled repeater of claim 4, wherein the second configuration includes at least one of a beam configuration, an on/off configuration and a time division multiplexing configuration.

6. The network-controlled repeater of claim 4, wherein the circuitry is further configured to:
perform a cell selection in response to the detected radio link failure; and
determine that a cell selected in the cell selection is provided by the base station.

7. The network-controlled repeater of claim 6, wherein the determining is based on a cell identifier of the selected cell.

8. The network-controlled repeater of claim 6, wherein the circuitry is further configured to transmit a connection re-establishment request message to the base station.

9. The network-controlled repeater of claim 8, wherein the circuitry is further configured to receive the second configuration from the base station.

10. The network-controlled repeater of claim 9, wherein the circuitry is further configured to request the second configuration from the base station.

11. The network-controlled repeater of claim 10, wherein the requesting includes transmitting a request of the second configuration in the connection re-establishment request message.

12. The network-controlled repeater of claim 10, wherein the requesting includes transmitting a request of the second configuration in a connection re-establishment complete message.

13.-22. (canceled)

23. A base station for a mobile telecommunications network, wherein the base station comprises circuitry configured to:
detect a radio link failure in a connection between a network-controlled repeater of the mobile telecommunications network and a cell provided by the base station; and
release, based on the detected radio link failure, a first configuration of a forwarding function of the network-controlled repeater.

24. The base station of claim 23, wherein the releasing of the first configuration includes deleting the first configuration.

25. The base station of claim 23, wherein the first configuration includes at least one of a beam configuration, an on/off configuration and a time division multiplexing configuration.

26. The base station of claim 23, wherein the releasing of the first configuration is based on a release timer of the base station.

27. The base station of claim 26, wherein the release timer is configured to indicate a release of the first configuration after a time period that corresponds to a duration of a radio link failure timer of the network-controlled repeater.

28. The base station of claim 23, wherein the circuitry is further configured to receive a connection re-establishment request message from the network-controlled repeater.

29.-73. (canceled)

74. A network-controlled repeater for a mobile telecommunications network, wherein the network-controlled repeater comprises circuitry configured to:
detect a radio link failure in a connection between the network-controlled repeater and a cell provided by a base station of the mobile telecommunications network; and
transmit, to the base station, a connection re-establishment request message that includes an indication of a radio link failure of the network-controlled repeater as re-establishment cause.

75. The network-controlled repeater of claim 74, wherein the circuitry is further configured to:
perform a cell selection in response to the detected radio link failure; and
determine that a cell selected in the cell selection is provided by the base station.

76.-137. (canceled)
